(19) United States
(12) Patent Application Publication
(10) Pub. No.: US 2017/0185744 A1
(43) Pub. Date: Jun. 29, 2017

(54) MEDICAL SUPPORT APPARATUS AND SYSTEM, AND NON-TRANSITORY COMPUTER READABLE MEDIUM

(71) Applicant: FUJIFILM Corporation, Tokyo (JP)

(72) Inventors: Yuki OKABE, Tokyo (JP); Rena KAMODA, Tokyo (JP)

(73) Assignee: FUJIFILM Corporation, Tokyo (JP)

(21) Appl. No.: 15/380,201

(22) Filed: Dec. 15, 2016

(30) Foreign Application Priority Data
Dec. 25, 2015 (JP) 2015-253081

(51) Int. Cl. G06F 19/00; G06F 9/44; G06F 3/0482

(52) U.S. Cl. CPC G06F 19/3456; G06F 3/0482; G06F 9/4443; G06F 19/345; G06F 19/322

(57) ABSTRACT

A medical support apparatus provides plural test data and plural medication data, the test data being data of stored combinations of a test item, a test value and date/time information of a diagnostic test performed to a patient body, the medication data being data of stored combinations of a type (name), a dose and an administration period of a medicine administered to the patient body. An acquisition unit acquires a relationship dataset constituted by the medication data of at least one medicine and the test data of at least one test item susceptible to influence of administering the medicine to the patient body. A display output control unit performs display control of a display screen having a plurality of relationship dataset fields in relation to the relationship dataset so as to arrange and display the dose and the test value adjacently to one another in a time sequence.

### CROSS-REFERENCE TO RELATED APPLICATION

This application claims priority under 35 USC 119 from Japanese Patent Application No. 2015-253081, filed 25 Dec. 2015, the disclosure of which is incorporated by reference herein.

### BACKGROUND OF THE INVENTION

1. Field of the Invention

The present invention relates to a medical support apparatus and system, and a non-transitory computer readable medium. More particularly, the present invention relates to a medical support apparatus and system in which medication data of a medicine and test data of a diagnostic test are displayed, and a causal relationship between medication of the medicine and a patient condition with the medicine can be recognized reliably, and a non-transitory computer readable medium.

2. Description Related to the Prior Art

A medical support apparatus is known in the field of medical instruments to support medical care of medical professionals, such as a doctor. The medical support apparatus handles and treats medical care data acquired in the course of medical care of a patient, and provides the doctor with the medical care data. The medical care data include test data and medication data. The test data are related to diagnostic tests or sample tests in relation to a patient, such as a test of a vital sign, blood test, urinalysis and the like. Examples of the test data are combinations of test items, test values, date/time information and the like. Examples of the test items of the vital sign include body temperature, heart rate, blood pressure and the like. Examples of the test items of the blood test include blood sugar, hemoglobin density, hematocrit and the like. The medication data are related to medicines administered to a patient. Examples of the medication data are combinations of types (names) of medicines, doses and administration periods.

U.S. Pat. Pub. No. 2016/253,460 (corresponding to JP-A 2015-095217) discloses the medical support apparatus for creating a display screen having a first display area for values of the test data and a second display area for periods of the medication data. A display panel or monitor of a client terminal apparatus is caused to display the display screen. The first display area for the test data indicates line graphs expressing changes of the test values of a plurality of the test items with time. The second display area for the medication data indicates values of the doses of the plural medicines, and a bar portion for expressing administration periods of the medicines.

In order to recognize a symptom (disease or health problem) and progress of a patient, and to decide a treatment plan for the patient, the doctor considers a causal relationship between the medication and a patient condition with very high importance, for example, occurrence of main effect of the medicine after the medication, occurrence of adverse effect of the medicine, and the like.

The causal relationship between the medication and the patient condition can be found by comparing changes of the dose of a medicine with time and changes in the test values of the test items with time, the test items being susceptible to influence of medication of the medicine, for example, blood pressure (vital sign) in the case of an antihypertensive agent, and blood sugar in the blood test in the case of insulin. However, it is impossible for a doctor completely to recognize the test items susceptible to influence of all of the medicines. It is considerably difficult to recognize the medication data between the medication and the patient condition according to highness in the number of the types of the medicines, and highness in the number of the test items susceptible to the influence.

It is important for the doctor readily to recognize the causal relationship between the medication and the patient condition in the technique for providing the medication data of plural medicines and the test data of the plurality of the test items to the doctor. However, a relationship between the test data and the medication data is unclear according to U.S. Pat. Pub. No. 2016/253,460 (corresponding to JP-A 2015-095217), in which the second display area for the medication data is discrete from the first display area for the test data. It is difficult to recognize the causal relationship between the medication and the patient condition rapidly.

### SUMMARY OF THE INVENTION

In view of the foregoing problems, an object of the present invention is to provide a medical support apparatus and system in which medication data of a medicine and test data of a diagnostic test are displayed, and a causal relationship between medication of the medicine and a patient condition with the medicine can be recognized reliably, and a non-transitory computer readable medium.

In order to achieve the above and other objects and advantages of this invention, a medical support apparatus provides plural test data and plural medication data, the test data being data of stored combinations of a test item, a test value and date/time information of a diagnostic test performed to a patient body, the medication data being data of stored combinations of a type, a dose and an administration period of a medicine administered to the patient body. An acquisition unit acquires a relationship dataset constituted by the medication data of at least one medicine for the medicine and the test data of at least one test item for the test item susceptible to influence of administering the medicine to the patient body. A display output control unit performs display control of a display screen having a plurality of relationship dataset fields in relation to the relationship dataset so as to arrange and display the dose and the test value adjacently to one another in a time sequence.

Preferably, the display screen includes first and second display areas. The first display area includes the relationship dataset fields, and also indicates a test value of a test item different from the test item indicated in the relationship dataset fields in a time sequence. The second display area indicates test values of plural test items at one time point in a display period of the first display area in a list form. The test item is constituted by a first test item displayed in the first display area, and a second test item displayed in the second display area, and including a test item different from the first test item.

Preferably, the display output control unit designates the first test item in the first display area and the second test item in the second display area among test items acquired by the acquisition unit in relation to the test data.

Preferably, furthermore, a receiver receives manually input designation of addition of a particular test item to the first test item without being designated by the display output control unit. The display output control unit adds the particular test item to the first test item and also to the second test item.

Preferably, assuming that the particular test item has been designated for the second test item, the display output control unit performs display of the designated second test item in a distinct display form from remaining the second test item.

Preferably, upon adding the particular test item to the second test item, the display output control unit performs display of a test value of alternative date/time information for a test value of the second test item of addition assuming that a test value of same date/time information as remaining the second test item is missing.

Preferably, the display output control unit performs display control to display the test value of the alternative date/time information in a distinct display form from a test value of the remaining second test item.

Also, a non-transitory computer readable medium for storing a computer-executable program is provided, the computer-executable program enabling execution of computer instructions to perform operations for providing plural test data and plural medication data, the test data being data of stored combinations of a test item, a test value and date/time information of a diagnostic test performed to a patient body, the medication data being data of stored combinations of a type, a dose and an administration period of a medicine administered to the patient body. The operations include acquiring a relationship dataset constituted by the medication data of at least one medicine for the medicine and the test data of at least one test item for the test item susceptible to influence of administering the medicine to the patient body. The operations include performing display control of a display screen having a plurality of relationship dataset fields in relation to the relationship dataset so as to arrange and display the dose and the test value adjacently to one another in a time sequence.

Also, a medical support system includes a medical support apparatus for providing plural test data and plural medication data, the test data being data of stored combinations of a test item, a test value and date/time information of a diagnostic test performed to a patient body, the medication data being data of stored combinations of a type, a dose and an administration period of a medicine administered to the patient body, and a client terminal apparatus connected to the medical support apparatus by network connection, and provided with the test data and the medication data by the medical support apparatus. The medical support system includes an acquisition unit for acquiring a relationship dataset constituted by the medication data of at least one medicine for the medicine and the test data of at least one test item for the test item susceptible to influence of administering the medicine to the patient body. A display output control unit performs display control of a display screen having a plurality of relationship dataset fields in relation to the relationship dataset so as to arrange and display the dose and the test value adjacently to one another in a time sequence.

Consequently, a causal relationship between medication of the medicine and a patient condition with the medicine can be recognized reliably, because the dose of the medicine and the test value can be arranged adjacently with one another.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a medical support system;

FIG. 2 is a data chart illustrating information in EMRs;

FIG. 3 is a data chart illustrating diagnostic images with related information;

FIG. 4 is a block diagram schematically illustrating a computer constituting each of a client terminal apparatus and a medical support apparatus;

FIG. 5 is a block diagram schematically illustrating circuit devices included in a CPU of the computer;

FIG. 6 is a table illustrating test item setting information or resource information;

FIG. 7 is a table illustrating relationship information;

FIG. 8 is a screen view illustrating a display screen;

FIG. 9 is a screen view illustrating information in a first display area;

FIG. 10 is a screen view illustrating part of the information in the first display area in enlargement;

FIG. 11 is a screen view illustrating information in a second display area;

FIG. 12 is an explanatory view illustrating information in a third display area;

FIG. 13 is an explanatory view illustrating information in a fourth display area;

FIG. 14 is a flow chart illustrating steps or processing in the medical support apparatus;

FIG. 15 is a screen view illustrating an item selection dialog box;

FIG. 16 is a screen view illustrating information in the first display area where a first test item is added;

FIG. 17 is a screen view illustrating an input dialog box for medication display;

FIG. 18 is a screen view illustrating information in the first display area where medication data is indicated in one table row;

FIG. 19 is an explanatory view illustrating a third preferred embodiment in which a test item can be added to second test items;

FIG. 20 is an explanatory view illustrating a fourth preferred embodiment in which different display forms are used between plural second test items;

FIG. 21 is a data chart illustrating test data of urinalysis;

FIG. 22 is an explanatory view illustrating a fifth preferred embodiment in which plural second test items with a difference in date/time information are displayed.

### DETAILED DESCRIPTION OF THE PREFERRED EMBODIMENT(S) OF THE PRESENT INVENTION

### First Embodiment

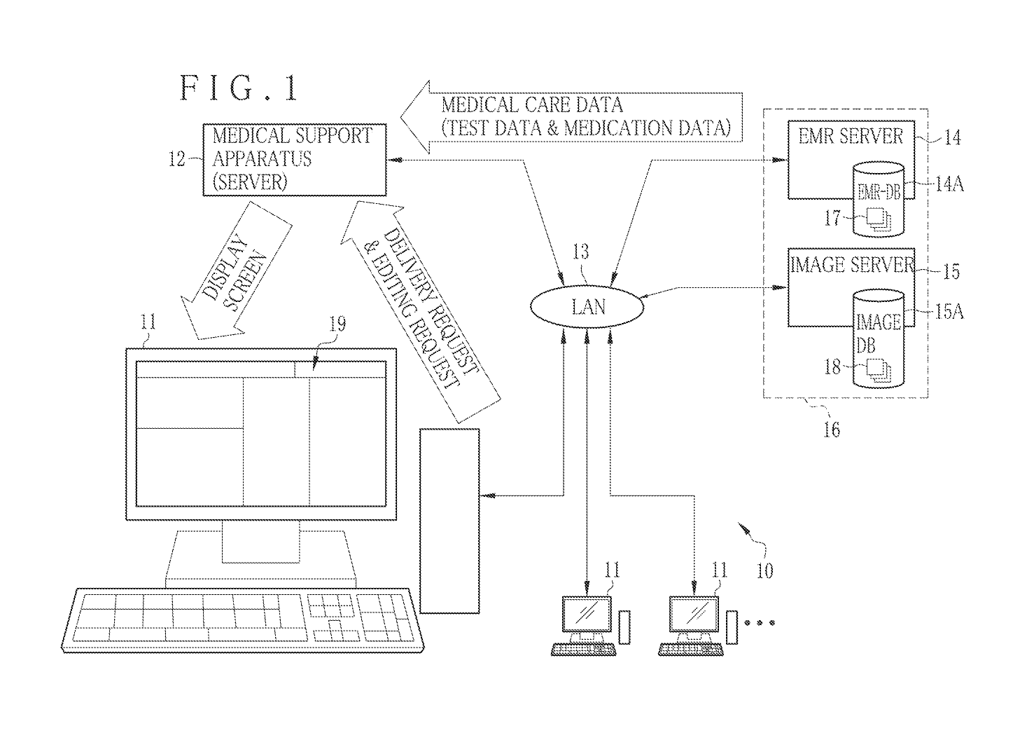

In FIG. 1, a medical support system 10 or clinical decision support system (CDSS) is installed in a medical facility (hospital facility), and includes a client terminal apparatus 11 or user terminal apparatus, and a medical support apparatus 12 or server apparatus. A LAN 13 or local area network as a suitable network is disposed in the medical facility, and interconnects the client terminal apparatus 11 and the medical support apparatus 12 in a communicable manner with one another.

Also, an EMR server apparatus 14 or electronic medical record server apparatus, and an image server apparatus 15 are connected with the LAN 13, and constitute a server cluster 16. An EMR database 14A or electronic medical record database is combined with the EMR server apparatus 14, and stores EMRs 17 (electronic medical records) in a searchable manner. An image database 15A is combined with the image server apparatus 15, and stores diagnostic images 18. The diagnostic images 18 are generated by medical imaging. In addition to the EMR server apparatus 14 and the image server apparatus 15, the server cluster 16 includes a report server apparatus with which a database stores medical reports containing results of image interpretation of the diagnostic images 18 by a radiologist in a searchable manner. Also, the server cluster 16 may include a gene information server apparatus with which a database stores gene information of patients in a searchable manner.

Each of the client terminal apparatuses 11, the medical support apparatus 12 and the server cluster 16 is constituted by a computer and programs installed in the computer. Examples of the computer are a personal computer, server computer, workstation and the like. Examples of the programs are control programs such as an operating system (OS), various applications and the like.

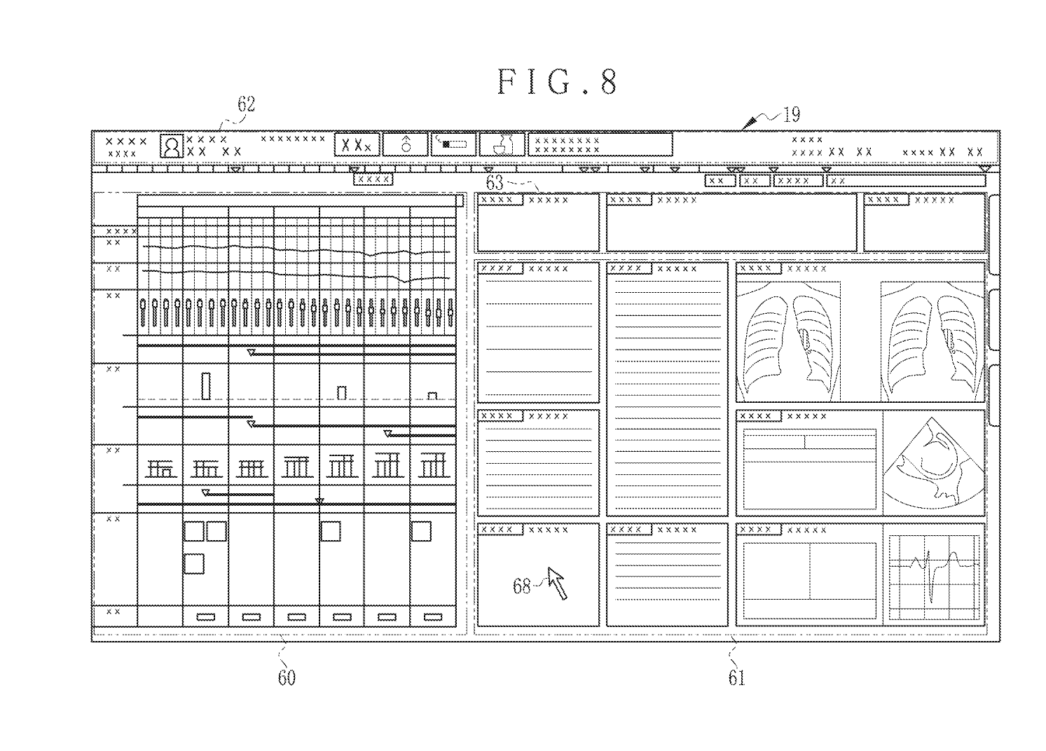

In order to support medical care of a doctor, the medical support apparatus 12 handles various medical care data acquired in the course of medical care of a patient, and provides the medical care data. The medical support apparatus 12 has a function of delivering a display screen 19 (See FIG. 8) containing various medical care data of the particular patient for facilitating analysis and decision of the doctor.

The medical care data includes test data and medication data. The test data are data related to diagnostic tests for a patient, inclusive of vital signs measurement, and a blood test, urinalysis and other sample tests, and the like. The medication data is data related to a medicine administered to the patient. Also, the medical care data includes the diagnostic images 18 from the image server apparatus 15, medical reports acquired from the report server apparatus, and the like.

The client terminal apparatuses 11 are operated by medical professionals, such as a doctor, nurse, medical technician for diagnostic tests, and the like. A plurality of the client terminal apparatuses 11 are disposed for various medical professionals and various hospital departments, such as an internal medicine, surgery, radiology, diagnostic tests, rehabilitation, and the like. The client terminal apparatuses 11 are used while various functions of the medical support apparatus 12 and the server cluster 16 are utilized for patient care, for example, in order to view the EMRs 17, the diagnostic images 18, or the display screen 19, or to input various medical care data to the EMRs 17. The client terminal apparatuses 11 can be a stationary type installed in the respective hospital departments, or a portable type manually carried by the respective medical professionals.

The medical support apparatus 12 receives a request for information delivery from the client terminal apparatus 11. Also, the medical support apparatus 12 obtains medical care data from the server cluster 16 after acquisition in the course of medical care to the patient in the medical facility. The medical support apparatus 12 creates the display screen 19 according to the medical care data, and delivers the display screen 19 to the client terminal apparatus 11 as a requester of the request for the information delivery.

Also, the medical support apparatus 12 receives a request for editing from the client terminal apparatus 11. The medical support apparatus 12 edits the display screen 19 according to the request for editing, and delivers the display screen 19 to the client terminal apparatus 11 as a requester of the request for the editing.

The medical support apparatus 12 creates the display screen 19 for display with a web browser, and delivers the display screen 19 to the client terminal apparatus 11. The medical support apparatus 12 issues an authorization key to the client terminal apparatus 11, and gives authorization for access to the medical support apparatus 12. After performing the authorization, the display screen 19 is displayed in the client terminal apparatus 11 after reception from the medical support apparatus 12.

The medical support apparatus 12 distributes the display screen 19 to the client terminal apparatus 11 in a format of XML data for web delivery created according to the XML (Extensible Markup Language) as a markup language. The client terminal apparatus 11 performs display processing to display the display screen 19 on the web browser according to the XML data. Also, it is possible to use another data description language instead of the XML, such as JSON (JavaScript Object Notation) and the like, JavaScript being a trade name.

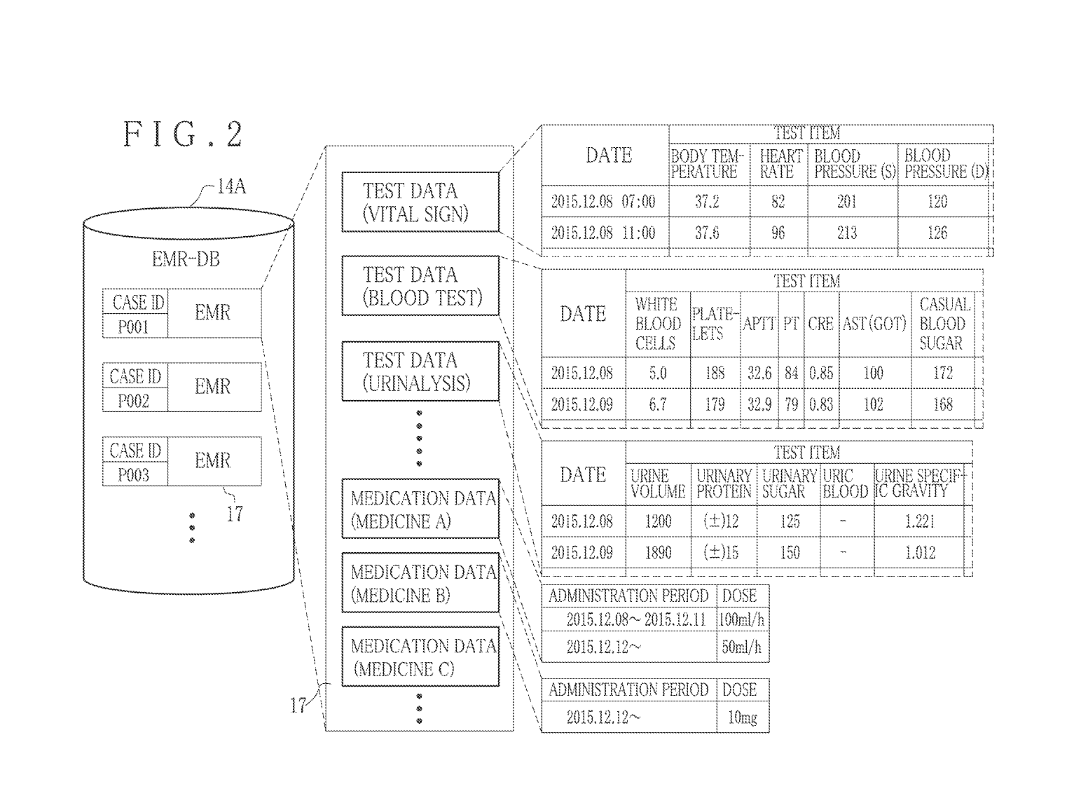

In FIG. 2, the EMRs 17 in the EMR database 14A are managed for the unit of the patient by association of a case ID (identification data), for example, P001, as signs and numbers for identifying each case or patient. The EMRs 17 in the EMR server apparatus 14 are searchable from the EMR database 14A by use of the case ID as a query.

The EMRs 17 have plural test data and plural medication data. The test data are data of test types of a vital sign, blood test, urinalysis and the like. Metadata are associated with the test data, including test items, test values, and test date/time information (date or time). Examples of the test items for the vital sign are body temperature, heart rate, blood pressure (systolic and diastolic) and the like. Examples of the test items for the blood test are the number of white blood cells, platelets, casual blood sugar and the like. The medication data are data of medicinal types (medicine names), such as medicines A and B. Metadata are associated with the medication data, including a dose and administration period.

Various patient data are recorded in the EMRs 17, including information of the case ID, name, sex, age and birthday of the patient, his or her preference of smoking and drinking, medical history, allergy and the like. Also, additional data are recorded in the EMRs 17 in a time sequential manner, including information of a request for a diagnostic test, creation of a medical report, surgery, medication and the like, information of patient events in the course of medical care of the patient, such as a first patient visit, hospital admission, hospital discharge and the like, and information of chief complaint, progress note, record of nursing, additional record of information from the family of the patient, and the like.

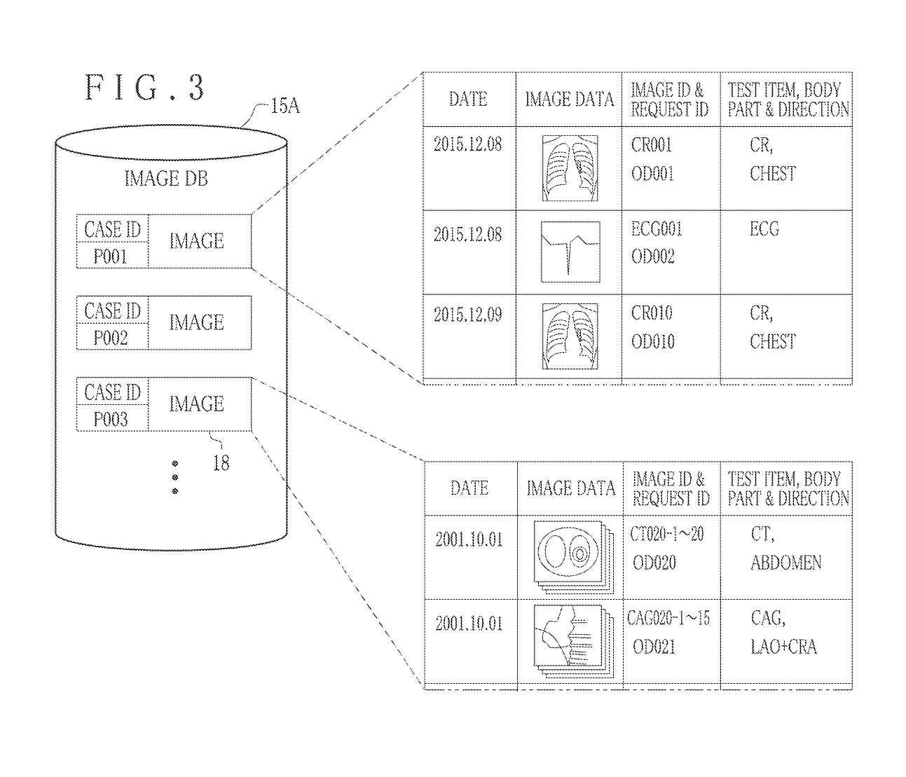

In FIG. 3, the diagnostic images 18 in the image database 15A are managed by the unit of the patients in association with the case IDs in the same manner as the EMRs 17. In the image server apparatus 15, the diagnostic images 18 are searchable from the image database 15A by use of a query of the case IDs, in the same manner as the EMR server apparatus 14.

The diagnostic images 18 are formed by imaging of various modalities, such as CR Imaging (Computed Radiography), CT imaging (Computed Tomography Imaging), MRI imaging (Magnetic Resonance Imaging), ECG test (electrocardiogram), CAG imaging (Coronary Angiography), US imaging (ultrasound imaging or ultrasonography), endoscopic imaging and the like. For example, the diagnostic images 18 of the CR, CT or MRI imaging are in a format according to the DICOM (Digital Imaging and Communications in Medicine).

A file of one set of the diagnostic images 18 is constituted by image data of the diagnostic images 18 and meta information, which includes imaging date/time information, image ID, request ID, imaging modality, body part, imaging direction and the like. The image server apparatus 15 transmits the diagnostic images 18 to the medical support apparatus 12 as medical care data together with the meta information.

The image ID is signs and/or numbers for identifying each of the diagnostic images 18. The request ID is signs and/or numbers for identifying a request for instructing each of imaging methods. For the imaging methods to form a plurality of the diagnostic images 18 at one imaging session, such as the CT imaging and CAG imaging, one request ID is assigned to the diagnostic images 18 commonly to express one imaging session of forming the plurality of the diagnostic images 18, which can be handled as one set of the images.

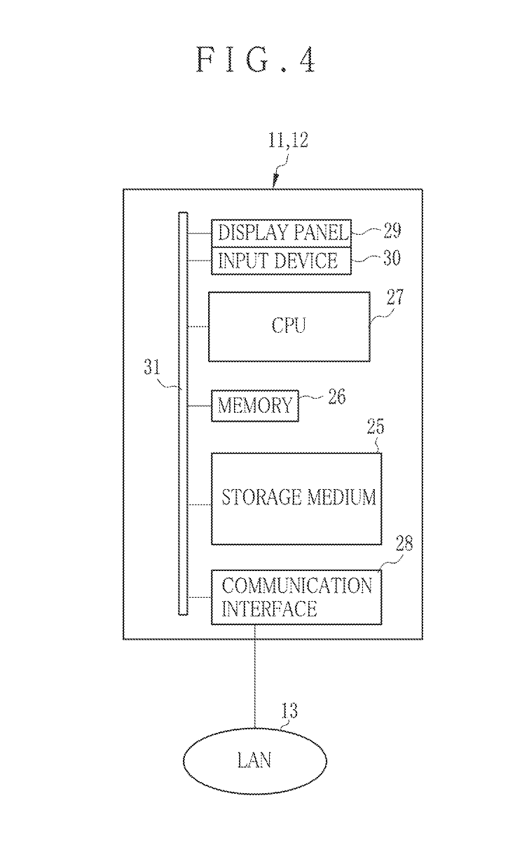

In FIG. 4, the client terminal apparatus 11 and the medical support apparatus 12 are constituted by computers of which structures are basically equal. Each computer has a storage medium 25 or storage device, a memory 26, a CPU 27 or central processing unit, a communication interface 28, a display panel 29 and an input device 30. A data bus 31 interconnects those circuit devices.

The storage medium 25 is a hard disk drive incorporated in the computer constituting the client terminal apparatus 11 and the like, or connected to the computer by a cable, network or the like. Also, the storage medium 25 may be a disk array having plural hard disk drives. The storage medium 25 stores a control program and various application programs such as the Operating System (OS), and display screen data for control pages associated with the programs.

The memory 26 is a working memory with which the CPU 27 performs tasks. The CPU 27 loads the memory 26 with the programs stored in the storage medium 25, and controls the various circuit devices in the computer by performing the tasks according to the program.

The communication interface 28 is a network interface for control of transmission of various data by use of the LAN 13. The display panel 29 displays a control page where an input action can be performed by use of the input device 30, such as a mouse, keyboard and the like. The control page has a function according to the GUI (graphical user interface). The computer constituting the client terminal apparatus 11 receives manual inputs from the input device 30 by use of the various menus in the control page.

In the following description, a sign A will be added to each of reference signs of components in the computer constituting the client terminal apparatus 11. A sign B will be added to each of reference signs of components in the computer constituting the medical support apparatus 12.

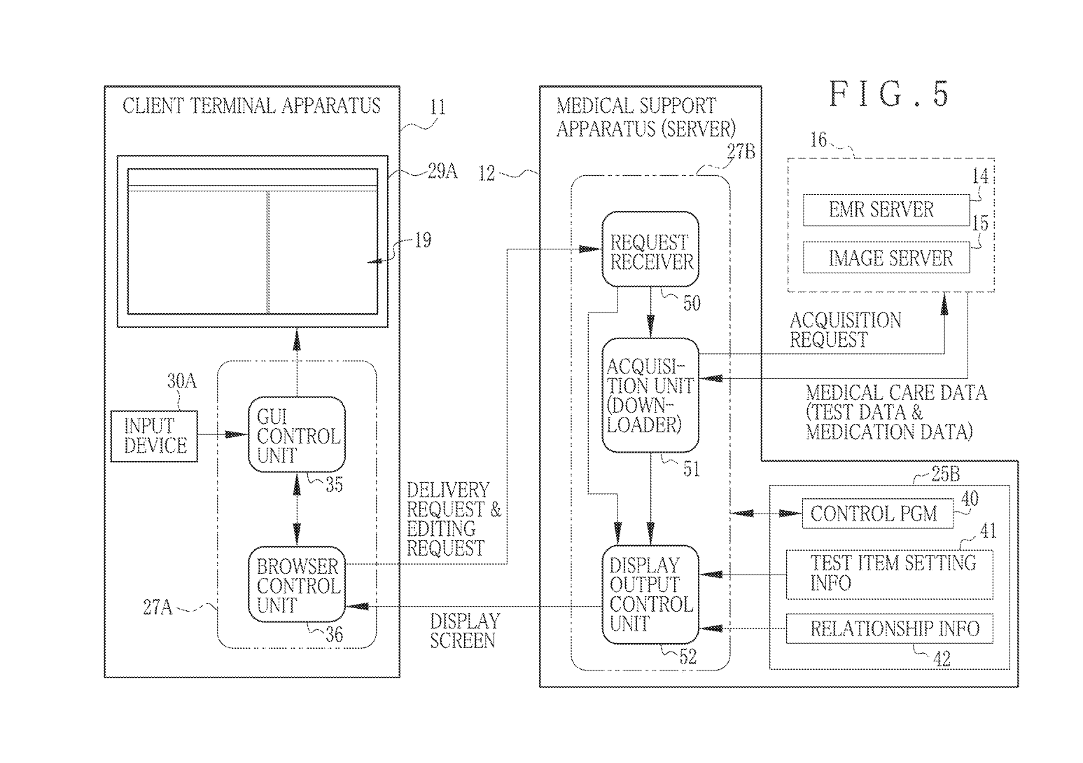

In FIG. 5, running the web browser causes a CPU 27A or central processing unit in the client terminal apparatus 11 to establish a GUI control unit 35 and a browser control unit 36 by cooperating with the memory 26 and the like.

A display panel 29A is controlled by the GUI control unit 35 and displays various control pages or views. An input device 30A is operated to perform input actions to the GUI control unit 35 by use of a control pages or views. Examples of the input actions are a request for information delivery of the display screen 19 to the medical support apparatus 12, and a request of editing the display screen 19. The GUI control unit 35 sends signals of the input actions to the browser control unit 36.

The browser control unit 36 controls operation of the web browser. The browser control unit 36 sends a delivery request and an editing request to the medical support apparatus 12, the delivery request being according to a request for the delivery from the GUI control unit 35, the editing request being according to a request for the editing.

The browser control unit 36 receives (downloads) image data of the display screen 19 from the medical support apparatus 12. The browser control unit 36 forms the display screen 19 according to the image data in a manner for display on the web browser, and sends the display screen 19 to the GUI control unit 35. The GUI control unit 35 drives the display panel 29A to display the display screen 19.

A control program 40 (computer-executable program) is stored in a storage medium 25B or storage device in the medical support apparatus 12. The control program 40 is an application program to cause a computer constituting the medical support apparatus 12 to function as a medical support apparatus.

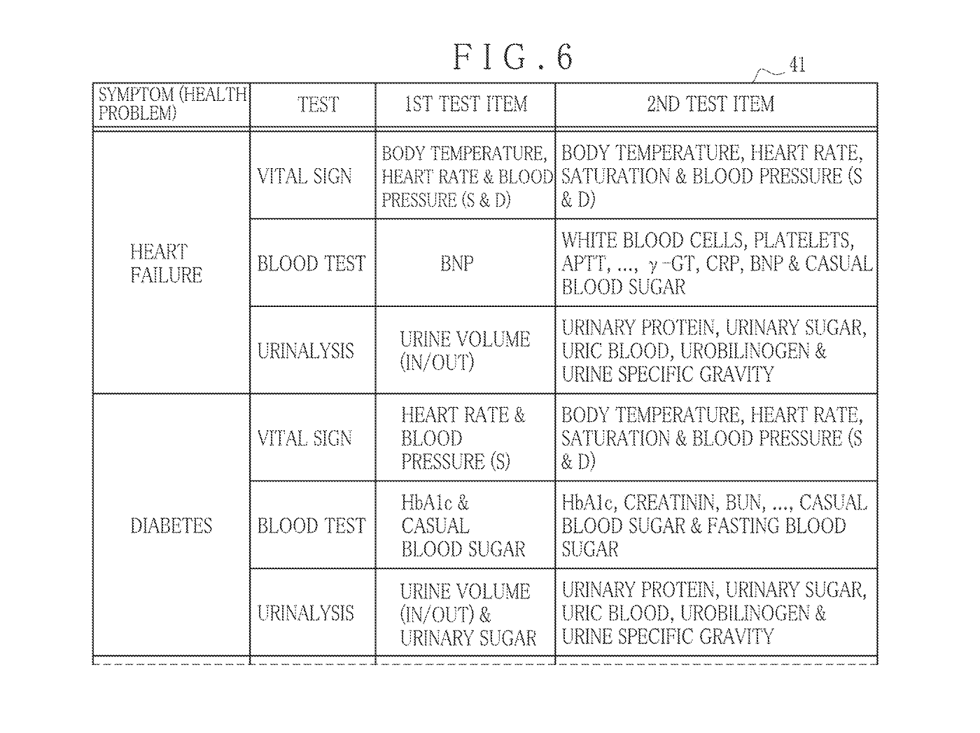

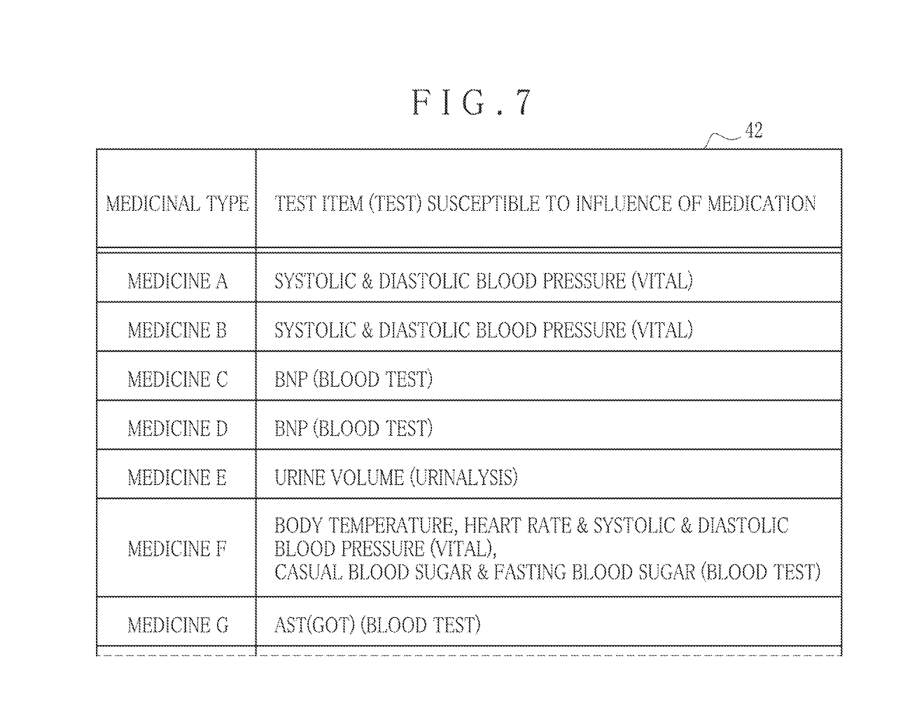

The storage medium 253 stores test item setting information 41 or resource information (in FIG. 6), and relationship information 42 or cross referencing information (in FIG. 7) required for generating the display screen 19, in addition to the control program 40.

In case the control program 40 is run, a CPU 27B or central processing unit in the medical support apparatus 12 cooperates with the memory 26, so that a request receiver 50, an acquisition unit 51 or downloader, and a display output control unit 52 (page generator or display processor) are established.

The request receiver 50 receives a request for information delivery and a request for editing from the client terminal apparatus 11. The request receiver 50 sends the request for information delivery to the acquisition unit 51, and sends the request for editing to the display output control unit 52.

The acquisition unit 51 generates an acquisition request to the server cluster 16 in response to the delivery request. Then the acquisition unit 51 receives medical care data from the server cluster 16 in response to the acquisition request. The acquisition unit 51 transmits the medical care data to the display output control unit 52.

The display output control unit 52 generates the display screen 19 according to the medical care data. Also, the display output control unit 52 edits the display screen 19 according to the editing request. The display output control unit 52 delivers the display screen 19 to the client terminal apparatus 11 as a requester of the delivery request or editing request.

In FIG. 6, test items (test records) for display on the display screen 19 are registered in the test item setting information 41 in units of symptoms (disease or health problem), such as heart failure, diabetes and the like. The test items for display on the display screen 19 include first test items and second test items for the types of the tests. The first test items are test items requiring special attention in a particular symptom. The second test items are test items which should be reviewed comprehensively in relation to the symptom. Therefore, the second test items include those different from the first test items. The number of the second test items is higher than that of the first test items.

Let the symptom be heart failure. Examples of designated test items as first test items of the vital sign are body temperature, heart rate and blood pressure (systolic and diastolic). Examples of designated test items as second test items are a saturation level (oxygen density in blood) in Addition to the body temperature, heart rate and blood pressure (systolic and diastolic). Let the symptom be diabetes. Examples of designated test items as first test items of the blood test are HbA1c (hemoglobin A1c or glycohemoglobin) and casual blood sugar. Examples of designated test items as second test items are creatinin, BUN (blood urea nitrogen) and fasting blood sugar in addition to HbA1c and casual blood sugar.

The display output control unit 52 reads out the first and second test items (test records) from the test item setting information 41 according to the symptom (disease or health problem) of the patient. The display output control unit 52 selectively sets test items to be displayed as the first test items and test items to be displayed as the second test items among all test items related to test data among medical care data, on the basis of the first and second test items being read out.

In FIG. 7, the relationship information 42 is constituted by test items which are susceptible to influence of medication of medicines and are registered in relation to the types of the medicines (medicine names). For example, a registered test item susceptible to influence of the medicines A and B is the blood pressure (systolic and diastolic). Registered test items susceptible to influence of the medicine F are the body temperature, heart rate, blood pressure (systolic and diastolic), casual blood sugar and fasting blood sugar. Some of the registered test items are common to two or more medicines. There are some of the medicines of which plural test items are susceptible to influence.

It is likely that plural relationship datasets are included in the medication data and the test data sent to the display output control unit 52 after acquisition in the acquisition unit 51, the relationship datasets being constituted by medication data of at least one medicine registered in the relationship information 42 and test data of at least one test item (test record) susceptible to influence of the medication of the medicine.

Note that influence of medication of a medicine is related both to pharmaceutical effects (medicinal effects) of the medicine, such as a drop of the blood pressure upon use of an antihypertensive agent, and reduction of fever upon use of an antipyretic agent, and to side effects, such as a decrease in white blood cells upon use of an anticancer agent, and liver dysfunction upon use of an antibiotic agent.

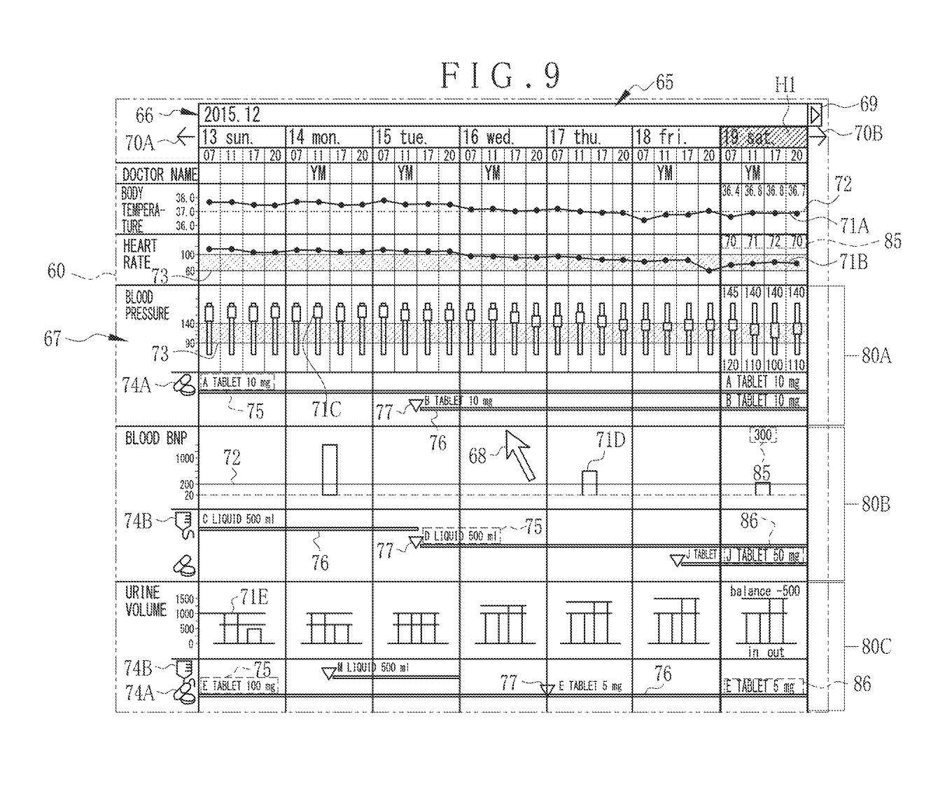

Plural relationship dataset fields 80A, 80B and 80C or cross referencing dataset fields are displayed on the display screen 19 by the display output control unit 52 according to the relationship information 42. See FIG. 9.

A doctor performs access to the medical support apparatus through the client terminal apparatus 11 for receiving authorization. An input page for a case ID is displayed on a web browser of the display panel 29A of the client terminal apparatus 11. The input page includes an input box and a send button for the case ID. In case the case ID of the patient is input to the input button and the send button is selected (pressed), the browser control unit 36 of the client terminal apparatus 11 sends a delivery request to the request receiver 50 of the medical support apparatus 12 inclusive of the case ID of the patient.

A case ID of the patient included in the delivery request is assigned to an acquisition request as a search query for transmission from the acquisition unit 51 to the server cluster 16. The server cluster 16 transmits the EMRs 17, the diagnostic images 18 and the like to the acquisition unit 51 as medical care data together with the case ID of the patient. The display output control unit 52 generates the display screen 19 in FIG. 8 according to the medical care data of the patient from the server cluster 16.

In FIG. 8, the display screen 19 includes a first display area 60 or test display area, a second display area 61 or diagnosis display area, a third display area 62 or personal display area, and a fourth display area 63 or comment display area. The first display area 60 is disposed on a left side in the display screen 19, and is approximately ⅓ as large as the display screen 19. The second display area 61 is disposed on a right side from the first display area 60, and is approximately ⅔ as large as the display screen 19. The third display area 62 is disposed in an uppermost portion in the display screen 19. The fourth display area 63 is disposed between the second display area 61 and the third display area 62.

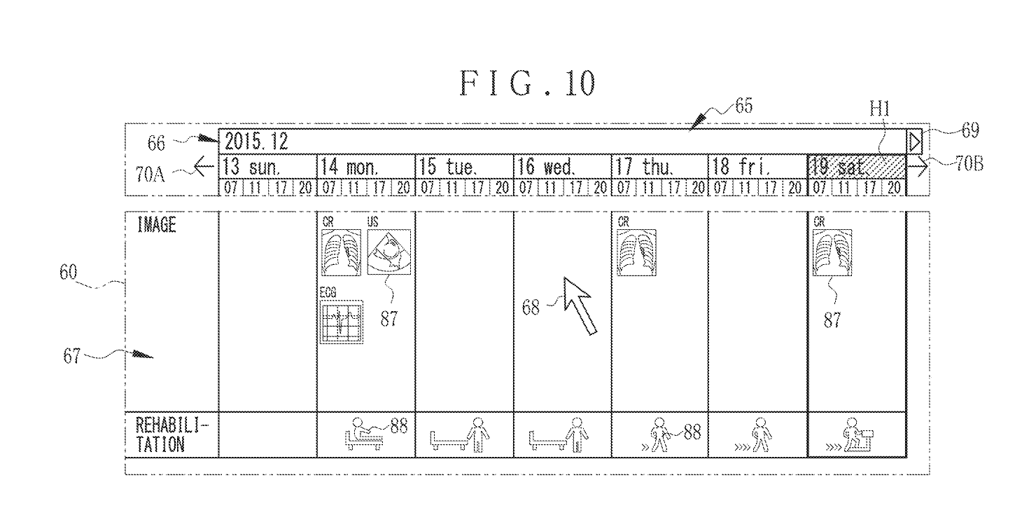

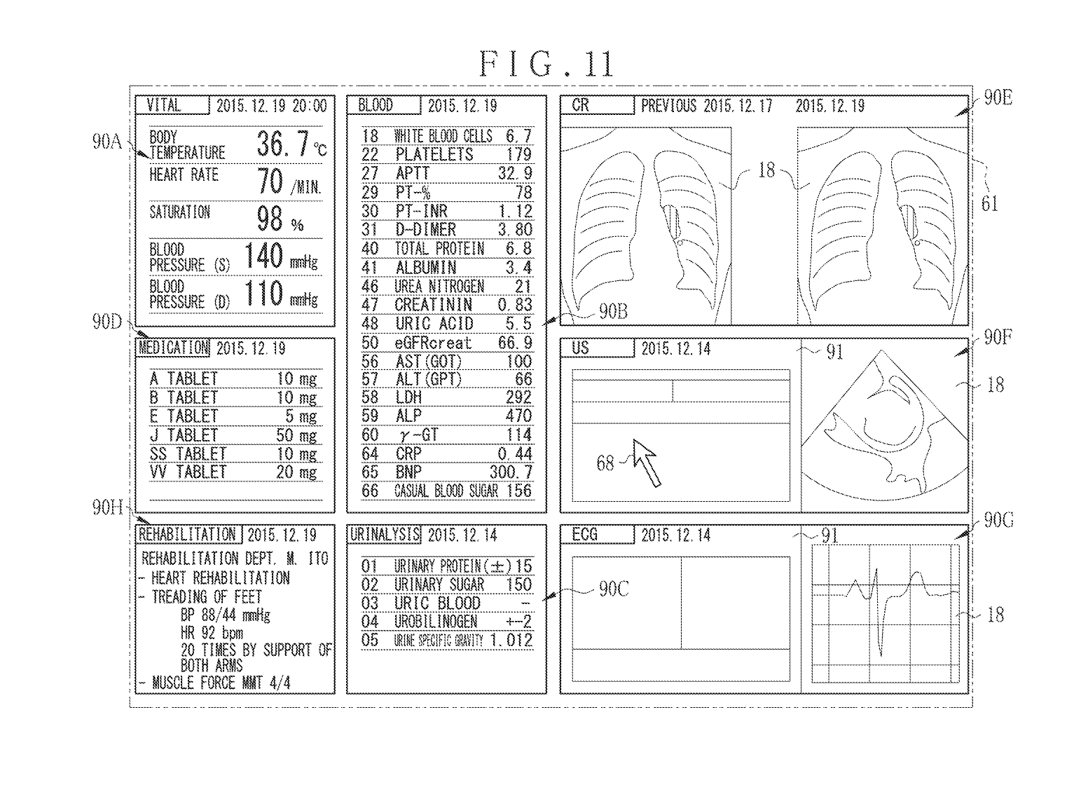

In FIGS. 9 and 10, a topic table 65 or test table is displayed in the first display area 60. A timeline bar 66 of a timeline axis with a time legend is disposed to extend in the horizontal direction of the table rows in an upper portion of the topic table 65. An item bar 67 (item list) of an item axis with an item table legend is disposed to extend in the vertical direction of the columns in a left portion of the topic table 65. An example of the symptom (disease or health problem) of the patient herein is heart failure. This is the same also in the drawings including FIG. 11.

An area of the timeline bar 66 includes three table rows arranged in the vertical direction, namely, a first table row for a year and month, a second table row for a calendar date, and a third table row for a time point. A cursor 68 or pointer is used for selecting one of plural dates in the second table row, for example, seven dates in one week. In case one date is selected with the cursor 68, the browser control unit 36 sends an editing request to the request receiver 50 inclusive of the selected date.

In FIGS. 9 and 10, a state of selecting the newest date is illustrated as emphasized by the hatching H1 (highlighted portion), the newest date being 2015.12.19 for acquisition of medical care data of the patient body. According to the delivery request, the display output control unit 52 initially creates the display screen 19 of FIGS. 9 and 10 in such a form that the newest date of the acquisition of the medical care data is disposed on the rightmost side along the timeline bar 66 and the newest date is selected.

Values of date/time information in the timeline bar 66 are arranged in a sequence from the left to right. A show/hide button 69 for folding and unfolding is disposed on a right side in the first table row of the year and month. In case the show/hide button 69 is selected (pressed) with the cursor 68, a display form of the timeline bar 66 is changed, for example, a visible area of a period of the timeline bar 66 is made as small as an area of two dates including the current date and a latest date before the current date, or is made as large as an area of one week. A return button 70A and a forward button 70B are disposed at horizontal ends of the second table row of the dates. In case the return button 70A is selected with the cursor 68, dates of the timeline bar 66 are stepped down toward the past by one date. In case the forward button 70B is selected with the cursor 68, dates of the timeline bar 66 are stepped up toward the current date by one date.

The item bar 67 is constituted by plural table rows arranged in the vertical direction. In a first uppermost table row in relation to the item bar 67, initial letters (for example, YM) of a name of a medical professional (doctor) of the treatment or diagnostic test are indicated in the horizontal direction of the medical care/test. In second to sixth table rows in relation to the item bar 67, information of the first test items (See FIG. 6) corresponding to the heart failure as symptom (disease or health problem) is indicated, including body temperature, heart rate, blood pressure (systolic and diastolic), BNP (brain natriuretic peptide) of the blood test, test items (test records) and scale of the test item of the urine volume in the urinalysis, and the like. For the scale of the test items except for the urine volume, a normal value or reference value is indicated.

Changes in the test values with time are indicated in table rows of the test items in the horizontal direction. Specifically, line graphs 71A and 71B are indicated in table rows of the body temperature and heart rate in the horizontal direction, and are defined by plotting various test values of time points. A schematic graph 71C is indicated in the table row of the blood pressure (systolic and diastolic) in the horizontal direction, and contains time sequential quadrilaterals each of which has an upper side line expressing a test value of the systolic blood pressure and a lower side line expressing a test value of the diastolic blood pressure. A bar graph 71D is indicated in the table row of BNP in the horizontal direction, and expresses the test value for each date of the blood test. A bar graph 71E is indicated in the table row of the urine volume in the horizontal direction, and expresses a water intake and urine volume for each date. A reference line 72 or a reference bar 73 is displayed in each of the table rows of the various test items except for the urine volume in the horizontal direction, the reference line 72 indicating a normal or reference value, the reference bar 73 indicating a range of the normal or reference value.

A tablet sign symbol 74A or a drip infusion sign symbol 743 is indicated in each of the table rows of the systolic and diastolic blood pressure, BNP and urine volume among the test items (test records), to represent medication of a medicine of which the test items are susceptible to influence. Descriptive information 75 in an alphanumeric form and a range bar 76 are indicated in the horizontal direction of the tablet sign symbol 74A and the drip infusion sign symbol 74B, the descriptive information 75 expressing the type of the medicine (medicine name) and the dose, the range bar 76 expressing an administration period of the medicine. An indicator sign 77 or pointing arrow is indicated with the range bar 76 at date/time information (date or time) of starting the medication, and at date/time information of changing the dose of the medicine. Date/time information of completing the medication of the medicine is expressed by a final end of the range bar 76.

The table rows of the blood pressure (systolic and diastolic), BNP and urine volume correspond to the relationship dataset fields 80A, 80B and 80C for indicating relationship datasets registered in the relationship information 42 in FIG. 7 for adjacent arrangement of the dose and test values in a time sequence. Specifically, the relationship dataset field 80A indicates doses of the medicines A and B and the test value of the blood pressure (systolic and diastolic) adjacently and in a time sequence. The relationship dataset field 80B indicates doses of the medicines C, D and J and the test value of BNP adjacently and in a time sequence. The relationship dataset field 80C indicates doses of the medicines E and M and the test value of the urine volume adjacently and in a time sequence.

Note that the indication of the adjacent arrangement between a table row of changes of the dose with time and a table row of changes of the test value with time, as expressed herein, means indication of near arrangement between a table row of changes of the dose with time and a table row of changes of the test value with time only with a small intermediate space. Arrangement with which a close relationship between the dose and the test value can be readily recognized is herein included in the feature of the adjacent arrangement.

In other words, the dose and the test value are so displayed that the dose and the test value are arranged close to one another, and that a time axis of the date/time information of the dose corresponds to a time axis of the test date/time information of the test value.

In case there is one test item susceptible to influence of plural medicines, the display output control unit 52 combines medication data of the plural medicines with test data of the single test item as one relationship dataset. Each of the relationship dataset fields 80A-80C is caused to indicate the medication data of the plural medicines with test data of the single test item.

As described above, the relationship dataset fields 80A-80C are indicated in the topic table 65. The topic table 65 is displayed in the first display area 60. Thus, the first display area 60 contains the three relationship dataset fields 80A-80C in the display screen 19. Furthermore, the first display area 60 indicates test values according to the time series, the test values including body temperature and heart rate (other than the systolic and diastolic blood pressures, BNP and the urine volume which are indicated in the relationship dataset fields 80A-80C).

Descriptive information 85 in an alphanumeric form is indicated at a date of 2015.12.19 selected by the cursor 68, to express a test value of each test item. Also, descriptive information 86 in an alphanumeric form is indicated at the date selected by the cursor 68 and in a larger form for the type (name) and dose of the medicines than the descriptive information 75. The descriptive information 85 and 86 is indicated only with the date selected by the cursor 68, but not with dates different from the selected date. This is effective in keeping the test value and dose visible distinctly without failure even in the presence of the descriptive information 85 and 86.

In FIG. 10, table rows of an image and rehabilitation are disposed in lower areas of table rows of each of the test items (test records). A thumbnail image 87 of the diagnostic image 18 is disposed and displayed on the table row of the image in the horizontal direction for each of the dates of performing the imaging of various modalities. A symbolic image 88 of illustration is disposed and displayed on the table row of the rehabilitation in the horizontal direction for expressing a step of the rehabilitation.

In FIG. 11, various windows are arranged in the second display area 61 to indicate details of medical care data, including a vital sign window 90A, a blood window 90B, a urine window 90C, a drug window 90D, a CR window 90E, an ultrasound window 90F, an ECG window 90G and a rehabilitation window 90H. The newest medical care data at the selected date on the timeline bar 66 are indicated in the display windows 90A-90H.

The vital sign window 90A indicates test values of plural test items (test records) of the vital signs in a list form. The blood window 90B indicates test values of plural test items of the blood test. The urine window 90C indicates test values of plural test items of the urinalysis. In the second display area 61, test values of the plural test items at one time point in the displayed period on the timeline bar 66 of the first display area 60 are indicated in the list form.

In the display windows 90A-90C, the second test items are indicated assuming that the symptom in the test item setting information 41 or resource information in FIG. 6 is heart failure. For example, the vital sign window 90A indicates test items of the body temperature, heart rate, saturation and blood pressure (systolic and diastolic) in a list foam. The blood window 90B indicates test items of the number of white blood cells, creatinin, BNP and casual blood sugar in a list form.

The drug window 90D indicates a type (name) and dose of medicines in a list form. Examples of the medicines in the drug window 90D also include medicines other than those indicated in the first display area 60. The medicines, which are not indicated in the first display area 60 but in the second display area 61, are such of which test items (test records) susceptible to influence of medication are not registered as first test items.

The CR window 90E indicates the diagnostic images 18 of current and previous sessions of the CR imaging. The ultrasound window 90F indicates the diagnostic image 18 of the ultrasonography and a small area view 91 of a medical report of a reduced size. The ECG window 90G indicates the diagnostic image 18 of waveform patterns of the ECG and the small area view 91 of the medical report. The rehabilitation window 90H indicates a record of rehabilitation of a medical professional (physical therapist and the like) in a rehabilitation department.

The display windows 90A-90H are selectable discretely by use of the cursor 68. An enlarged window of each of the display windows 90A-90H is caused to appear on the display screen 19 in a popup manner upon the selection with the cursor 68. It is possible with the enlarged window to view all of the test values in the test items (test records), or the diagnostic image 18 of the full size and the medical report.

Assuming that medical care data are available at a date selected on the timeline bar 66, the medical care data are indicated in the display windows 90A-90H. Assuming that medical care data are missing at a date selected on the timeline bar 66, the latest medical care data among the medical care data acquired earlier than the date selected on the timeline bar 66 are indicated in the display windows 90A-90H.

In FIG. 11, information items of which medical care data are available at the date of 2015.12.19 selected on the timeline bar 66 include information items of the vital sign, blood test, medication and CR imaging, and record of rehabilitation. The acquired medical care data at the date 2015.12.19 are indicated in the display windows 90A, 90B, 90D, 90E and 90H.

In contrast, information items of which medical care data are missing at the date of 2015.12.19 include information items of the urinalysis, ultrasonography and ECG. The latest data among the medical care data acquired earlier than the date 2015.12.19 are indicated in the display windows 90C, 90F and 90G, for example, 2015.12.14 in the urine window 90C for the urinalysis.

Also, it is possible to indicate a frame line with the display windows 90A-90H where medical care data is available at a calendar date selected with the timeline bar 66, to express the availability of the medical care data. A color of the background of the display windows 90A-90H can be changed for the availability of medical care data at the calendar date selected with the timeline bar 66. In short, it is possible to indicate the display windows 90A-90H where medical care data is available at the calendar date selected with the timeline bar 66, in a visually distinct manner from the display windows 90A-90H where medical care data is missing.

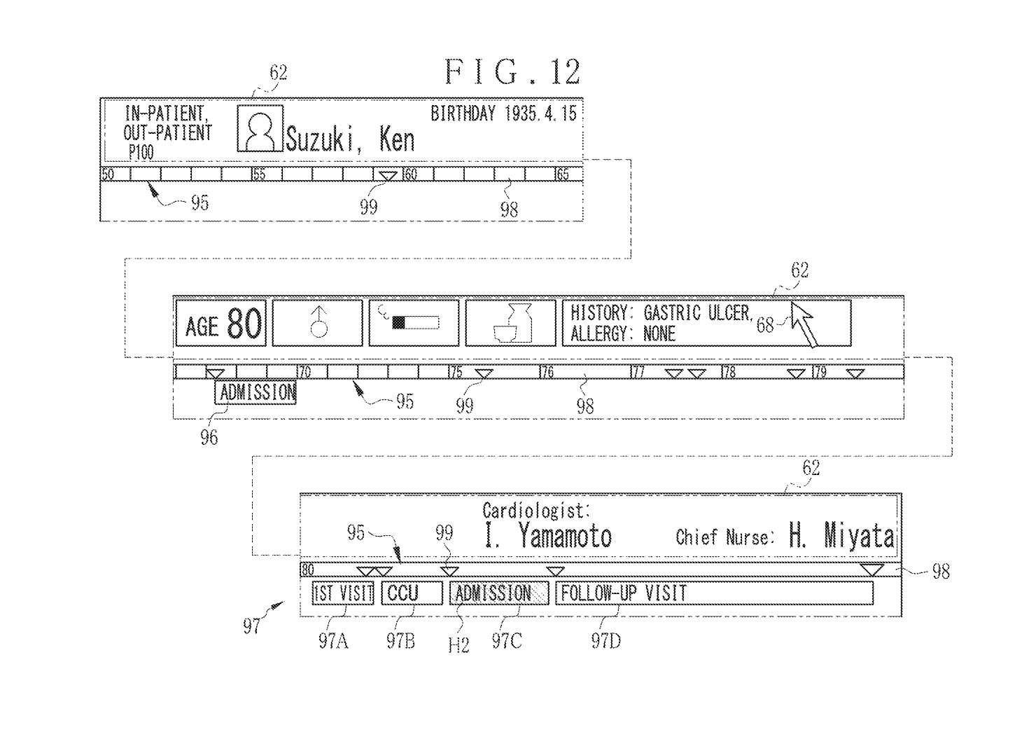

In FIG. 12, the third display area 62 is enlarged and displayed in three parts. The third display area 62 indicates a set of case information of the patient from a left side to the center, inclusive of a case ID, name, sex, age, birthday, preference, past disease and allergy. Information of medical professionals are indicated on a right side of the third display area 62, including a hospital department and name of a doctor of the patient, and a name of a chief nurse in association with the patient.

A scale bar 95 for the medical history (history log meter), an admission history button 96 and phase switching buttons 97 (for patient events) are indicated in a lower portion of the third display area 62. In contrast with the timeline bar 66 indicating as short a period as one week in the topic table 65, the scale bar 95 is used for simply indicating a medical history of a relatively long period from the past to the present of the patient, for example, 30 years from 50 to 80 of the age. Plural age range fields 98 of quadrilateral segments are arranged in the scale bar 95 forages of the patient. An indicator sign 99 or pointing arrow is disposed at each of the age range fields 98 of occurrence of a patient event, such as hospital admission, hospital discharge, surgery and the like.

Among the age range fields 98, the age range field 98 of a current age of the patient has a largest length (for example, the age range field 98 for the age of 80). A length of the age range field 98 of a period 1-5 years ago (for example, the age range field 98 for the age of 75-79) is smaller than a length of the age range field 98 of the current age. A length of the age range field 98 of a still earlier period (for example, the age range field 98 for the age of 50-74) is smaller than a length of the age range field 98 of the period 1-5 years ago. In short, a size of a field of a period earlier than the present time point by a predetermined time (for example, period of the age of 75-80) per unit time is set longer than a size of a remaining period (for example, period of the age of 50-74). The scale bar 95 makes it possible easily to grasp a medical history of the patient in his or her lifetime.

The admission history button 96 is a button for indicating a history of past hospital admission of the patient. Assuming that the patient does not have experience of the hospital admission, the admission history button 96 does not appear.

The admission history button 96 is displayed under the scale bar 95 corresponding to a period of the hospital admission of the patient in the past. In case the admission history button 96 is selected (pressed) with the cursor 68, a hospital discharge summary is displayed on the display screen 19 in a popup form, including abbreviated description of test results of diagnostic tests performed in the period of the hospital admission.

The phase switching buttons 97 include a first visit button 97A, a CCU button 97B or coronary care unit button, a hospital admission button 97C and a follow-up visit button 97D, which correspond respectively to phases (patient events) of patients. The phase switching buttons 97 are disposed under the scale bar 95 in a similar manner to the admission history button 96 for periods of the phases.

In case the phase switching buttons 97 are selected (pressed) by the cursor 68, the browser control unit 36 sends an editing request to the request receiver 50. A display form of the display screen 19 is switched suitably for each of the phases (patient events). For example, in case the first visit button 97A is selected, the first display area 60 displays a schematic view and test results in place of the topic table 65, the schematic view having a region of interest (the heart for the heart failure, the liver for the diabetes, and the like) of the symptom of the patient in a marked form, the test results being for diagnostic tests performed for the patient in the initial patient visit. In case the follow-up visit button 97D is selected, the first display area 60 displays the topic table 65 of which the item bar 67 is set as small in a folded form as areas of two dates including the current date and a latest date of medical care before the current date.

The display output control unit 52 initially generates the display screen 19 in a condition of selecting one of the phase switching buttons 97 corresponding to an event of recent occurrence to the patient according to the delivery request. Note that the event of the recent occurrence to the patient is the hospital admission. The hospital admission button 97C is selected as emphasized with hatching H2 (highlighted portion).

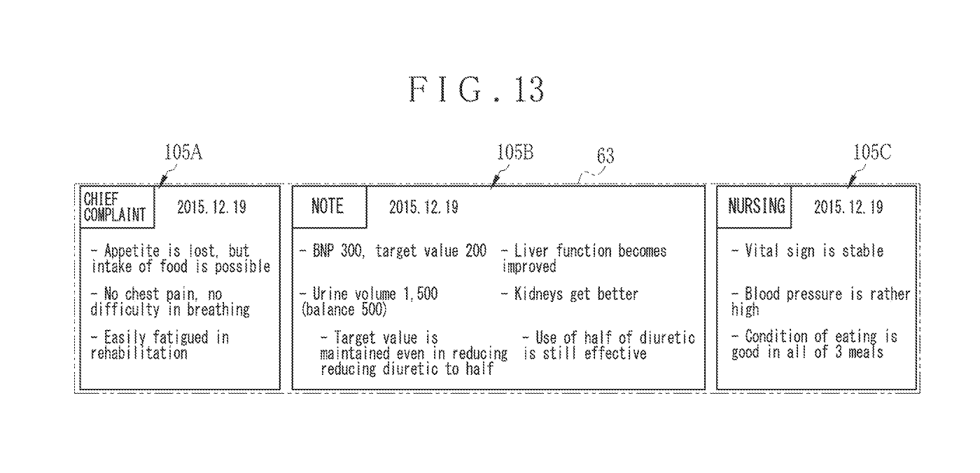

In FIG. 13, the fourth display area 63 contains plural windows in a manner similar to the second display area 61, inclusive of a chief complaint window 105A of a patient, a note window 105B of a doctor, and a nursing window 105C of a nurse. The newest medical care data are indicated in the display windows 105A-105C at the date selected on the timeline bar 66 in the same manner as the second display area 61.

The chief complaint window 105A indicates chief complaint of the patient. The note window 105B indicates a progress note of a hospital department of a doctor viewing the display screen 19. The nursing window 105C indicates a record of nursing. Date/time information (date or time) is also indicated with information in each one of the display windows 105A-105C.

In addition to the display windows 105A-105C or in place of those, other screen windows can be displayed in the fourth display area 63, including a history window for displaying past symptoms (disease or health problem), allergy and the like, a family window for displaying information from the family of the patient, a medication history window for displaying a medicine having been used by the patient before the hospital admission, and an additional problem window for displaying other symptoms of the patient after the hospital admission or after starting the follow-up visit.

Also, those screen windows to be displayed can be changed over according to the manipulation of the phase switching buttons 97. For example, the history window and the medication history window can be displayed only in case the first visit button 97A is selected (pressed). The family window can be displayed in case the first visit button 97A is selected and in case the follow-up visit button 97D is selected.

Note that a sequence or screen layout of the display windows 90A-90H in the third display area 62 and the display windows 105A-105C in the fourth display area 63 can be predetermined according to the control program 40, or can be changeable by customization of a doctor or medical professional with his or her preferences.

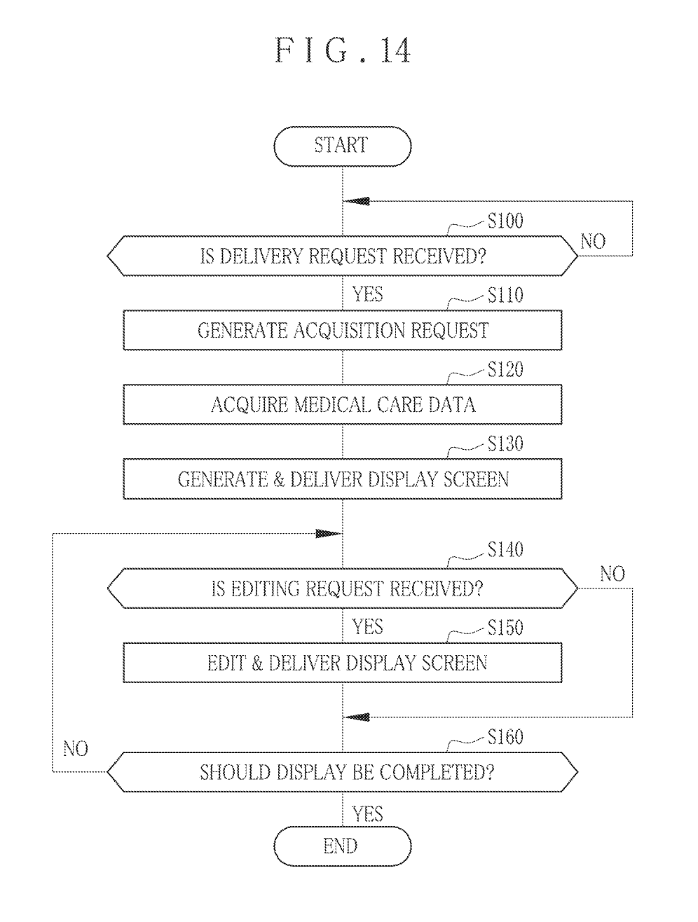

The operation of the above construction is described now by referring to a flow in FIG. 14. At first, a doctor performs access to the medical support apparatus 12 with the client terminal apparatus 11, to perform the communication connection by establishment of authorization. Then the display panel 29A of the client terminal apparatus 11 displays an input page for inputting a case ID.

He or she inputs the case ID of the patient to the input box of the input page, and presses the send button with the cursor 68. The client terminal apparatus 11 sends the delivery request for the display screen 19 to the medical support apparatus 12.

In the medical support apparatus 12, the request receiver 50 receives the delivery request (yes in a step S100). The delivery request is sent to the acquisition unit 51. The acquisition unit 51 sends an acquisition request to the server cluster 16 in a step S110. Medical care data of the patient from the server cluster 16 according to the acquisition request is acquired by the acquisition unit 51 in a step S120. The medical care data includes a relationship dataset. In short, the step S120 is an acquisition step of acquiring the relationship dataset.

The medical care data of the patient is transmitted by the acquisition unit 51 to the display output control unit 52. The display output control unit 52 generates the display screen 19 according to the medical care data of the patient in a step S130. The display screen 19 is delivered to the client terminal apparatus 11 as a requester of the delivery request.

In the client terminal apparatus 11, the browser control unit 36 receives (downloads) the display screen 19 from the medical support apparatus 12, and controls the display panel 29A to display the display screen 19 by use of the GUI control unit 35.

Assuming that the patient event of the recent occurrence to the patient is the hospital admission and assuming that the symptom of the patient is the heart failure, then the display screen 19 of FIGS. 8-13 is displayed on the display panel 29A.

In FIG. 9, the first display area 60 in the display screen 19 indicates the three relationship dataset fields 80A-80C by arranging a plurality of the relationship datasets each one of which contains data of the dose and the test value arranged adjacently in a manner of a time series. Even while plural values of the medication data and the test data are displayed, the use of the relationship dataset fields 80A-80C can clarify a relationship between the dose of the medicine and chronological changes of the test value of the test item (test record) susceptible to influence of the medication of the medicine. A doctor can readily grasp a causal relationship between the medication and the patient condition visually. It is possible for the doctor to check the progress of the symptom (disease or health problem) of the patient easily, and to decide the treatment plan suitably.

For example, according to the relationship dataset field 80A where the doses of the medicines A and B and test value of the blood pressure (systolic and diastolic) are displayed adjacently in a time sequence, it is found that the medicine B is administered on the date 2015.12.15 in addition to the medicine A, and that main effect of lowering the blood pressure can be obtained remarkably. Thus, appropriateness in deciding the medication of the medicine B can be confirmed.

In the first display area 60, test values of the test items (test records) other than test items indicated in the relationship dataset fields 80A-80C are indicated in a time series. A display form of the first display area 60 is clarified, as it is possible to view not only the changes of the test values of the test items susceptible to influence of medication of a medicine but also changes of the test values of the remaining test items.

In FIG. 11, the second display area 61 indicates test values of plural test items at one time point in the period range in the first display area 60 in a list form. Test items other than the first test items, which are displayed in the first display area 60, are included in the second test items indicated in the list form. Thus, it is possible to recognize the patient condition precisely and comprehensively.

Test items (test records) for display in the first display area 60 as the first test items and test items for display in the second display area 61 as the second test items are determined by the display output control unit 52 according to the test item setting information 41 or resource information of FIG. 6. It is possible for a doctor easily to view changes of the test values with time for the test items corresponding to the symptoms (disease or health problem) of the patient and details of the changes with time.

He or she views the display screen 19 and selects a date on the timeline bar 66 or one of the phase switching buttons 97 with the cursor 68 as required. The client terminal apparatus 11 transmits an editing request for the display screen 19 to the medical support apparatus 12.

The request receiver 50 in the medical support apparatus 12 receives an editing request (yes in a step S140). The editing request is transmitted to the display output control unit 52.

Assuming that a date on the timeline bar 66 is selected with the cursor 68, the display output control unit 52 changes over displayed data to the date selected by the cursor 68, the displayed data including the descriptive information 85 and 86 and an emphasized form of the hatching H1 in the first display area 60. Also, medical care data in the display windows 90A-90H in the second display area 61 is updated to become the newest medical care data at the selected date with the cursor 68. Assuming that the phase switching buttons 97 are selected (pressed) with the cursor 68, the display output control unit 52 changes over the display screen 19 to a form according to each of the phases (patient events). The display output control unit 52 delivers the display screen 19 being edited to the client terminal apparatus 11 as a requester of the editing request in a step S150. Those steps in series are repeated until an instruction for completing the display of the display screen 19 is generated (yes in a step S160).

A patient condition should be precisely checked up at the time of the first patient visit. A treatment plan should be decided at the time of the hospital admission after evaluating effect of the treatment with a medicine. Improvement of the patient condition should be checked at the time of the follow-up visit by comparison of current and previous results of the diagnostic tests. In short, there are differences in the point of view of analyzing the test results according to the phases (patient events) of the medical care. It is possible appropriately to analyze the test results according to the phases of the medical care by changing over the information in the display screen 19 suitably for the phases of the medical care in the present embodiment.

In the first embodiment described above, there is no example in which medication data of the same medicine is indicated in the plural relationship dataset fields 80A-80C in a repeated form. In contrast, medication data of the same medicine may be indicated in the plural relationship dataset fields 80A-80C in a repeated form for the medicine F in FIG. 7, namely, in association with the plural test items susceptible to influence of medication of the medicine. Note that one test item can be predetermined to be indicated in the relationship dataset fields 80A-80C to avoid indication of medication data of the same medicine in a repeated form in association with the plural test items susceptible to influence of medication of the medicine.

Note that the second test items (test records) can include a test item other than the first test items. It is unnecessary for the second test items to include the first test items.

### Second Embodiment

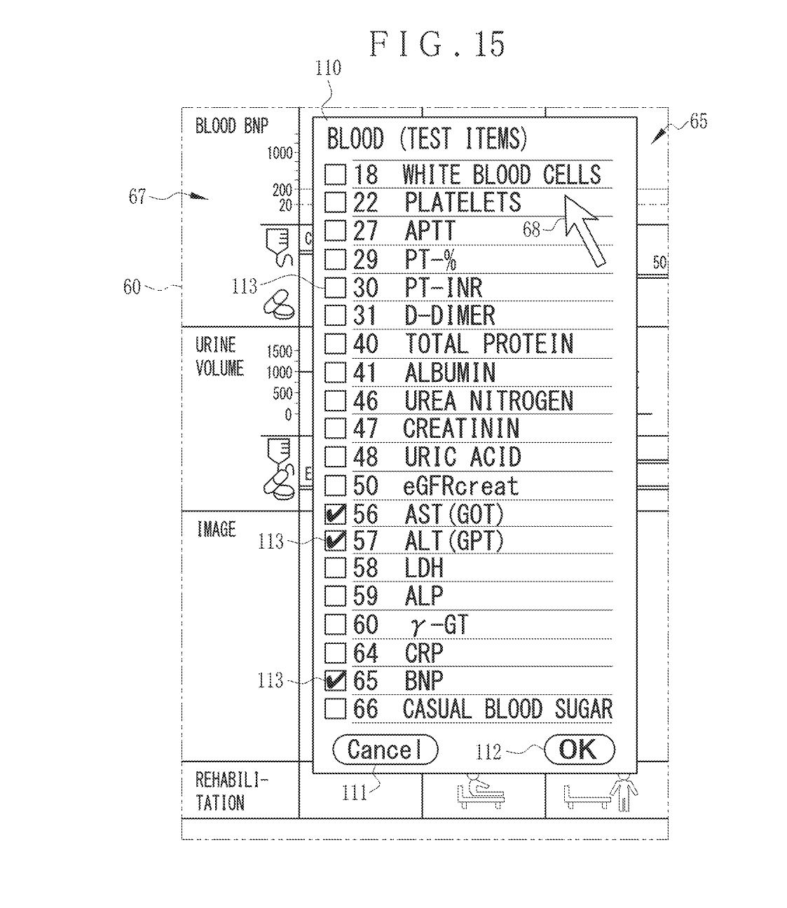

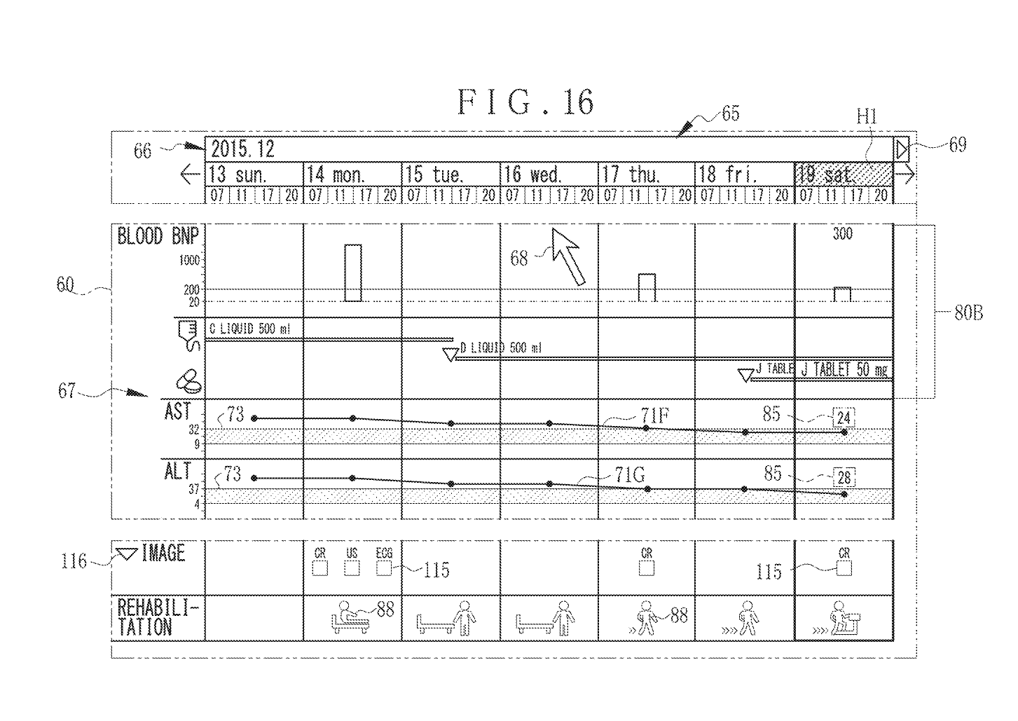

In contrast with the first embodiment in which the first test items for display are designated according to the test item setting information 41 or resource information, test items for display as first test items are settable according to preferences of a doctor in a second embodiment of FIGS. 15 and 16.

In FIG. 15, an item selection dialog box 110 is used for receiving manual inputs for designation of addition and deletion to add a test item (test record) of the blood test to the first test items, or delete the test item of the blood test from the first test items. The item selection dialog box 110 is indicated on the topic table 65 in a popup form by performing double click of a mouse with the cursor 68 at a table row of the blood test along the item bar 67 (item list).

All the test items related to test data of the blood test acquired by the acquisition unit 51 are indicated in the item selection dialog box 110 in a list form. A cancel button 111 and an OK button 112 are disposed in a lower portion of the item selection dialog box 110.

Check boxes 113 are disposed beside respectively the portions of the test items (test records). One of the check boxes 113 of which a check mark is indicated is set as a first test item. The doctor selects the check boxes 113 with the cursor 68 for a test item for addition to the first test items, to turn on a check mark, or selects the check boxes 113 with the cursor 68 for a test item for deletion from the first test items, to turn off a check mark. Selecting (pressing) the OK button 112 with the cursor 68 causes the browser control unit 36 to transmit an editing request to the request receiver 50 in a form inclusive of the designation for addition or deletion of the first test items, namely, a selected state of the check boxes 113. The request receiver 50 receives the editing request. The request receiver 50 functions as a designation receiver.

In FIG. 15, BNP has been set already for the first test item. AST (GOT) or aspartate transaminase (glutamic oxaloacetic transaminase), and ALT (GPT) or alanine aminotransferase (glutamic pyruvic transaminase) are newly designated for addition to the first test items as particular test items.

The display output control unit 52 adds the new particular test items (test records) to the first test item after the request receiver 50 receives designation of the new test items for the addition. In FIG. 15, AST(GOT) and ALT(GPT) are designated for the addition. The display output control unit 52 adds AST(GOT) and ALT(GPT) to the first test item.

The display output control unit 52 delivers the display screen 19 to the client terminal apparatus 11 as a requester of the editing request, the display screen 19 including the first test items and the designated particular test items added to the first test items. In FIG. 16, a table row of AST(GOT) and a table row of ALT(GPT) are added under the table row of BNP of the blood test on the item bar 67. Line graphs 71F and 71G are displayed in the table row of AST(GOT) and the table row of ALT(GPT) in the horizontal direction, the graphs being formed by plotting test values of the plural dates.

Addition of the table row for the first test items, it is likely that the topic table 65 becomes spread in the horizontal direction and cannot be contained in the display screen 19 in an unchanged form. For this structure, the display output control unit 52 reduces a size of the new table row in the horizontal direction.

In FIG. 16, a size of the table row of the image is shortened in the horizontal direction. A quadrilateral icon box 115 or sign is displayed in the table row of the image in the horizontal direction at a display size approximately ⅕ as large as the thumbnail image 87 in place of the thumbnail image 87 of the first embodiment. The use of the icon box 115 shortens the range of the table row of the image, for the display screen 19 to contain the topic table 65.

A show/hide button 116 for folding and unfolding is disposed in a table row of the image and functions in the same manner as the show/hide button 69 on the right side along the timeline bar 66, In case the show/hide button 116 is selected (pressed) by the cursor 68, a display form of the table row of the image is changed over between a display form with the icon box 115 of FIG. 16 and a display form with the thumbnail image 87 of FIG. 10 of the first embodiment. Note that a vertical scroll bar (not shown) is disposed with the topic table 65 while the thumbnail image 87 is displayed, because the topic table 65 cannot be contained in the display screen 19 at one time.

Therefore, it is possible easily to view changes of the test value of a first test item of interest with time in the topic table 65, as a first test item to be indicated in the topic table 65 is settable selectively. It is possible to set changes of a test value of a particular test item undisplayed easily, the particular test item having low importance among the first test items for consideration in the medical decision.

Designation for the addition and deletion in the item selection dialog box 110 displayed in a popup manner in the topic table 65 can be performed, so that it is unnecessary to use transition to a subsidiary page for designation for the addition or deletion.

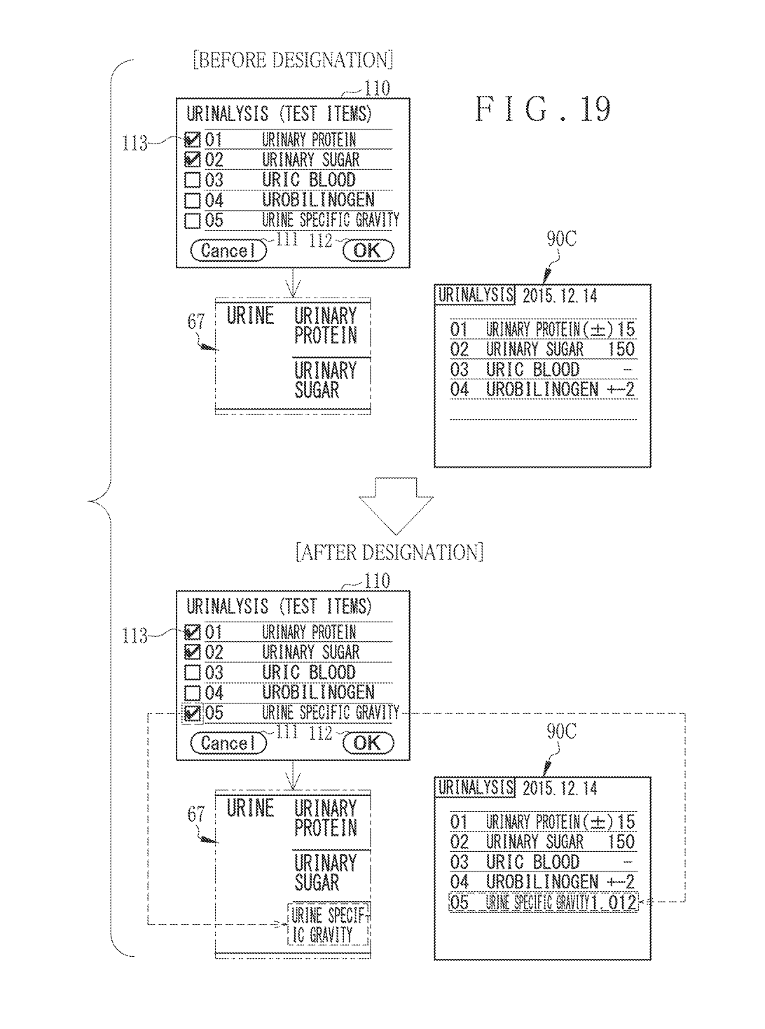

In FIGS. 15 and 16, test items of the blood test are added to or deleted from the first test items. Furthermore, test items can be added to or deleted from the first test items by use of the item selection dialog box 110 in relation to other vital signs or test items of urinalysis. See FIG. 19.

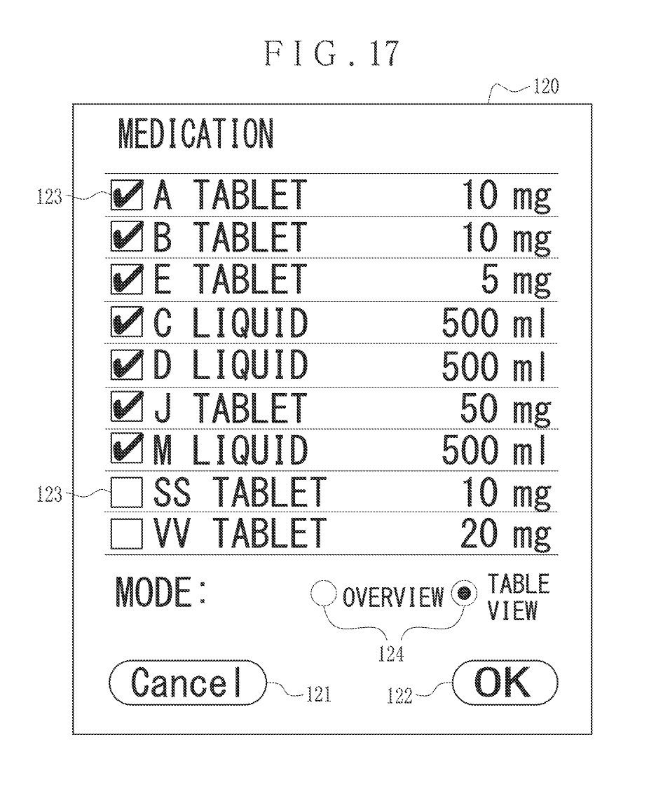

Also, the second test item (test record) can be changeable by manual operation of a doctor in addition to the first test item. Furthermore, an input dialog box 120 for medication display in FIG. 17 can be displayed, so that a display form in the topic table 65 can be changeable by manual operation of a doctor, in relation to medication data, as well as a display form of a medicine of medication of the medication data.

All of medicines related to the medication data acquired by the acquisition unit 51 are displayed in the input dialog box 120 in a list form. A cancel button 121 and an OK button 122 are disposed in a lower area of the input dialog box 120.

Check boxes 123 are disposed beside respectively the names of the medicines. One of the check boxes 123 of which a check mark is indicated expresses a medicine of which medication data is displayed in the topic table 65. The doctor selects one of the check boxes 123 with the cursor 68 for a medicine for displaying medication data in the topic table 65, to turn on a check mark, or selects one of the check boxes 123 with the cursor 68 for a medicine for hiding medication data in the topic table 65, to turn off a check mark.

A radio button 124 is used for setting a display form of the medication data. “Overview” is a form of displaying medication data of the medicines in one table row instead of the relationship dataset fields 80A-80C of the first embodiment. “Table view” (Specific) is a form of arranging areas of the test data and medication data in the relationship dataset fields 80A-80C in the manner of the first embodiment. A selected one of the “Overview” and “Table view” is set by use of the radio button 124.

In case the OK button 122 is selected (pressed) with the cursor 68, the browser control unit 36 sends the editing request to the request receiver 50 in a manner inclusive of the selected condition of the check boxes 123 and the radio button 124. The display output control unit 52 adds the medication data of the medicine to the topic table 65 according to the designation from the request receiver 50. Otherwise, the display output control unit 52 deletes medication data of the medicine from the topic table 65 according to the designation for an undisplayed form from the request receiver 50.

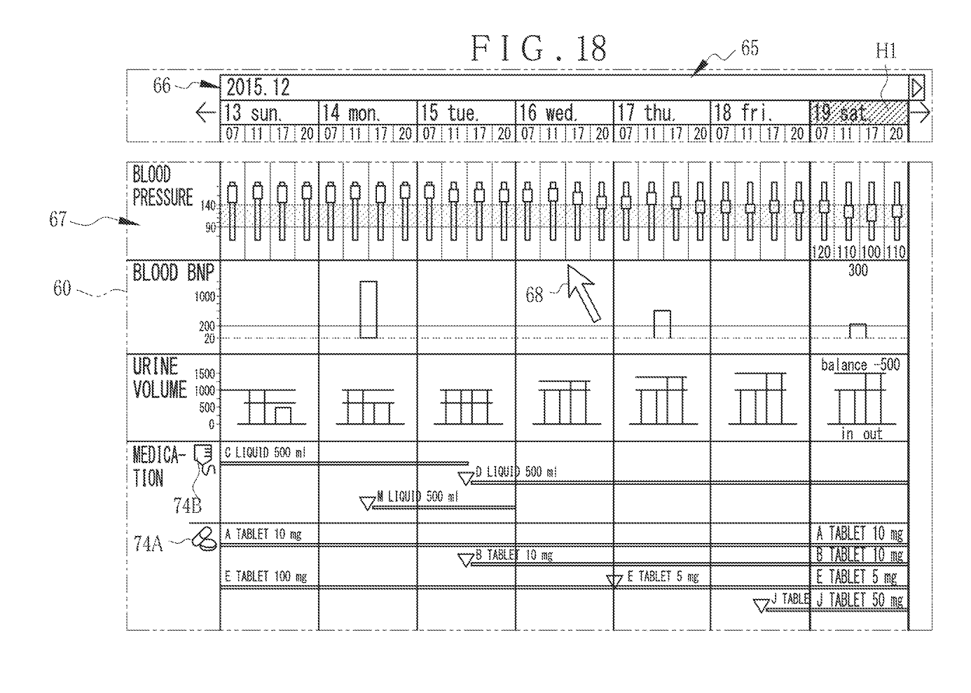

In case the “Overview” for the display form is selected with the radio button 124, the display output control unit 52 performs control to display the topic table 65 in the first display area 60 with one table row of medication data of the medicines in FIG. 18. The table row of the medication includes a first sub row for the drip infusion sign symbol 74B and a second sub row for the tablet sign symbol 74A. The medication data of the medicine of the drip infusion is indicated in the first sub row for the drip infusion sign symbol 74B in the horizontal direction. The medication data of the tablet is indicated in the second sub row for the tablet sign symbol 74A in the horizontal direction.

Therefore, it is possible easily to view changes of the dose of a medicine of interest with time in the topic table 65, as a medicine of which medication data is indicated in the topic table 65 is settable selectively. It is possible to set a dose of a second medicine undisplayed easily, the second medicine having low importance for consideration in the medical decision.

The changeable display form of the medical care data is advantageous for changing the display form according to the doctor's preferences. For example, the “Table view” is selected to arrange the medication data and test data in the relationship dataset fields 80A-80C assuming that he or she wishes to view a relationship between the medication data and test data. The “Overview” is selected to arrange the medication data in the single table row assuming that he or she wishes to perform access with low importance in a relationship between the medication data and test data.

### Third Embodiment

In the second embodiment described above, displaying a designated test item (test record) for addition to the first test item is not performed by way of the second test item in the second display area 61 assuming that the designated test item has not been specified as the second test item in advance of the designation for the addition. It is impossible to satisfy requirements of a doctor for reviewing and considering the designated test item for the addition carefully although he or she wishes to pay special attention to the designated test item.

A third preferred embodiment of FIG. 19 is provided, in which assuming that a test item of which designation for the addition to the first test items is received has not been set as a second test item before the designation for the addition, then the designated particular test item of the designation for the addition is added also to the second test item.

In FIG. 19, an example of designating a test item (test record) of urinalysis for the addition is illustrated. In an upper portion of the drawing, a state before the designation for the addition is displayed. In a lower portion of the drawing, a state after the designation for the addition is displayed. Before the designation for the addition, the test items of the urinary protein and urinary sugar are determined as the first test items as indicated in the item selection dialog box 110 and the item bar 67 (item list). The test items of the uric blood and urobilinogen are determined as the second test items as indicated in the urine window 90C in addition to the urinary protein and urinary sugar. No designation of the urine specific gravity is made for a second test item.

In the condition before the designation for the addition, assuming that the urine specific gravity is set as a first test item in the item selection dialog box 110, then the display output control unit 52 adds the urine specific gravity to the first test items as illustrated in the item bar 67 after the designation for the addition, and adds the urine specific gravity to the second test items as illustrated in the urine window 90C after the designation.

Consequently, the designated test item (test record) for the addition is indicated in both of the first and second display areas 60 and 61 reliably by adding the test item to the second test items after receiving the designation for addition to the first test items. It is possible to satisfy requirements of a doctor for reviewing and considering the designated particular test item for the addition carefully.

### Fourth Embodiment

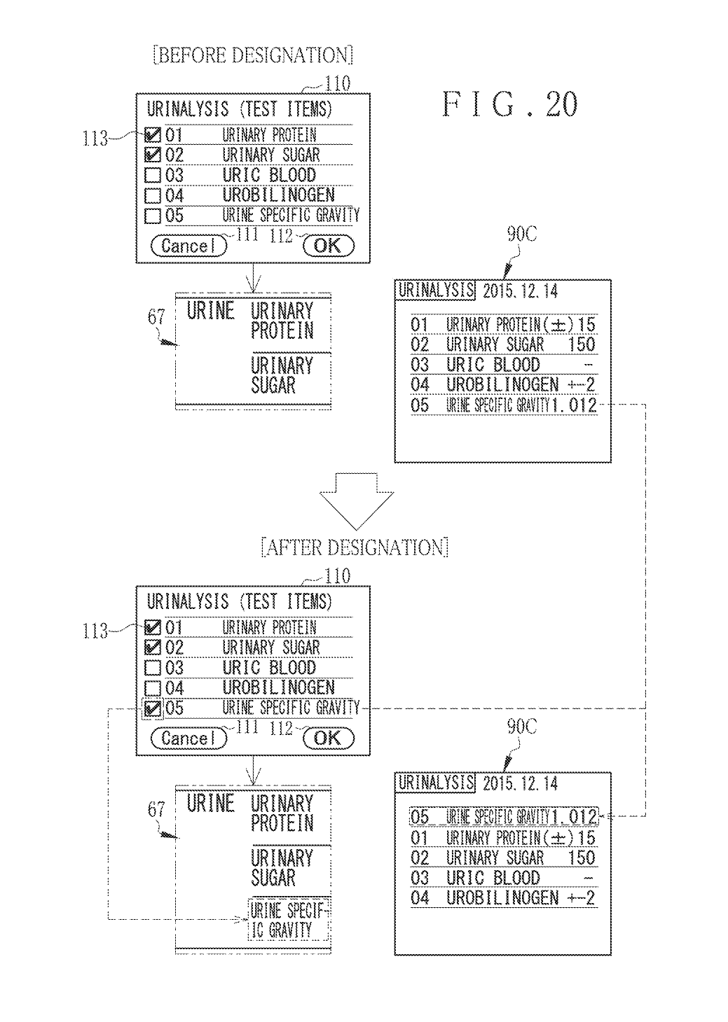

Assuming that a test item of which designation for addition to the first test items has been received has been determined as an initial second test item, then the initial (particular) second test item is indicated in a display form distinct from remaining second test items. See FIG. 20.

In FIG. 20, an example of additionally designating the test item (test record) of the urinalysis similar to that of FIG. 19 is illustrated. In an upper area, information before the addition is illustrated. In a lower area, information after the addition is illustrated. In a manner similar to FIG. 19, designated first test items are test items of the urinary protein and urinary sugar as indicated in the item selection dialog box 110 and with the item bar 67 (item list). Designated second test items are test items of uric blood, urobilinogen and urine specific gravity in addition to the urinary protein and urinary sugar as indicated in the urine window 90C. The test items are indicated in the urine window 90C in a sequence of the urinary protein, urinary sugar, uric blood, urobilinogen and urine specific gravity.

In the condition before the designation for the addition, assuming that the urine specific gravity is set as a first test item in the item selection dialog box 110, then the display output control unit 52 adds the urine specific gravity to the first test items as illustrated in the item bar 67 after the designation for the addition, and displaces the urine specific gravity from the lowest location to the uppermost location in the list as illustrated in the item bar 67 after the designation. Thus, the urine specific gravity is indicated in a distinct display form from the remaining second test items.

Thus, it is possible to satisfy the requirements of the doctor for reviewing the designated particular test items (test records) for the addition in the same manner as the third embodiment, as the initial designated second test items are indicated in a different display form from the remaining second test items.

Furthermore, other methods can be used for indicating the particular (initial) second test item distinctly from the remaining second test items. In place of or in addition to the method of FIG. 20, it is possible to surround the particular second test item with a frame line, or to indicate the same in a winking manner, or to display a background of the particular second test item in a distinct color from that of the remaining second test items.

### Fifth Embodiment

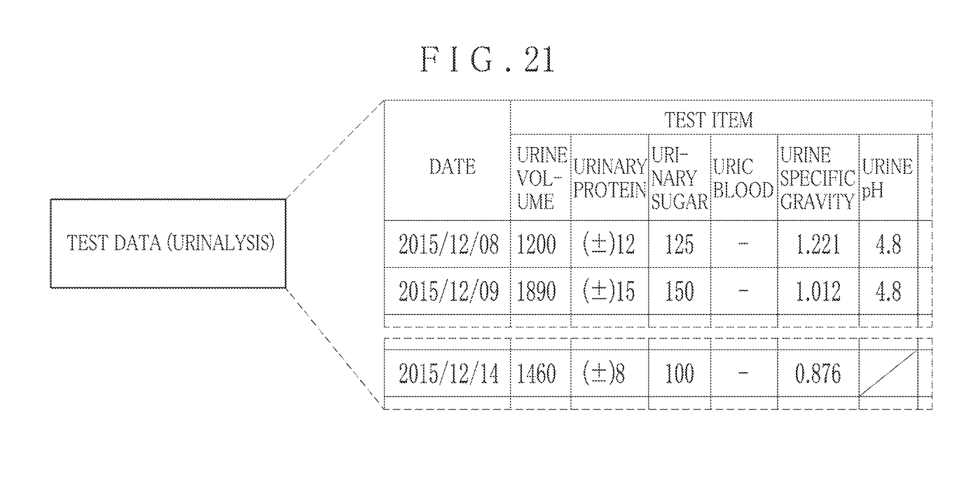

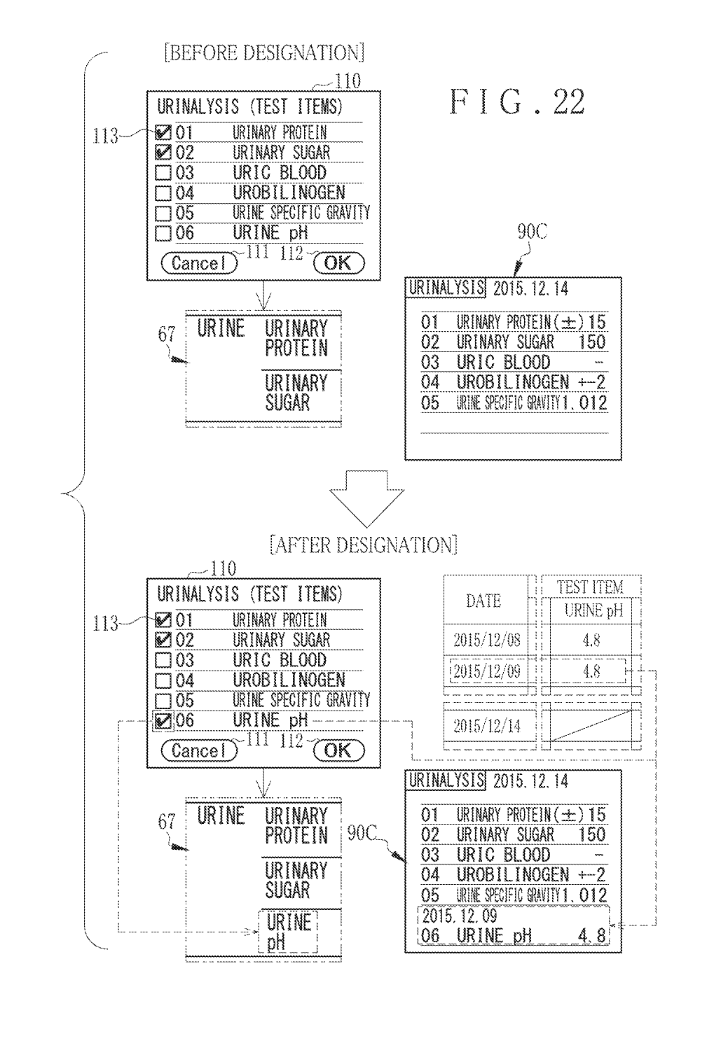

In FIGS. 21 and 22, a test value of alternative date/time information (date or time) is indicated assuming that one wishes to add test items (test records) of addition to the first test items also to the second test items, and assuming that a test value of the same date/time information as the remaining second test items is missing in relation to a test value of the additional second test items. The test value of the alternative date/time information is indicated in a distinct display form from the test value of the remaining second test items.

In FIG. 21, test data of urinalysis of a particular patient are illustrated. Test values of test items of the urine volume, urinary protein, urinary sugar, uric blood, urine specific gravity and urine pH (potential of hydrogen) are available at dates other than a date of 2015.12.14. However, a test value of the urine pH is missing at the date of 2015.12.14.

In FIG. 22, an example of additionally designating the test item (test record) of the urinalysis similar to that of FIGS. 19 and 20 is illustrated, in relation to the patient with test data of the urinalysis illustrated in FIG. 21. In an upper area, information before the addition is illustrated. In a lower area, information after the addition is illustrated. In a manner similar to FIG. 20, designated first test items are test items of the urinary protein and urinary sugar as indicated in the item selection dialog box 110 and with the item bar 67 (item list). Designated second test items are test items of uric blood, urobilinogen and urine specific gravity in addition to the urinary protein and urinary sugar as indicated in the urine window 90C. No designation of urine pH is made for the second test items. In the urine window 900, test values of the test items of the date of 2015.12.14 are indicated.

In the condition before the designation for the addition, assuming that the urine pH is set as a first test item in the item selection dialog box 110, then the display output control unit 52 adds the urine pH to the first test items as illustrated in the item bar 67 after the designation for the addition. In the urine window 900 after the designation for the addition, the test value of 4.8 at an alternative date of 2015.12.9 is indicated for the urine pH. The date 2015.12.09 is displayed in a table row disposed higher by one row, so that the urine pH is indicated in a distinct form from the remaining second test items.

Thus, it is possible to satisfy requirements of a doctor for reviewing designated test items (test records) for the addition in the same manner as the third and fourth embodiments by displaying the test value of the alternative date/time information (date or time) assuming that a test value is missing at the same date/time information as the remaining second test item in relation to the additional second test item. Also, it is possible visually to clarify the alternative date/time information of the test value different from the date/time information of the test value of the diagnostic test of the remaining second test items, as the test value of the alternative date/time information is displayed in a distinct display form from the test value of the remaining second test item.

Furthermore, other methods can be used for indicating the test value of alternative date/time information distinctly from test values of the remaining second test items. In place of or in addition to the method of FIG. 22, it is possible to surround the test value of the alternative date/time information with a frame line, or to indicate the same in a winking manner, or to display a background of the test value of the alternative date/time information in a distinct color from that of the test values of the remaining second test items.

Furthermore, an example of the test value of the alternative date/time information to be displayed can be preferably a test value of date/time information relatively near to that of the remaining second test item (test record), for example, a test value of the latest date/time information before, or the earliest date/time information after, that of the remaining second test item.

In the embodiments, the timeline bar 66 in the topic table 65 extends horizontally. The item bar 67 (item list) extends vertically. However, the item bar 67 may extend horizontally.

The timeline bar 66 may extend vertically.

In the above embodiments, the date/time information (date or time) of the diagnostic test is a calendar date and a time point. However, the date/time information (date or time) can be only one of the date and the time point. Also, information of a time series can be used for the date/time information, for example, a time zone, period and the like.

It is also noted that, assuming that the patient has visited a hospital department different from that of the doctor viewing the display screen 19, a progress note of the different hospital department can be displayed on the display screen 19 in a popup form by simple manipulation, for example, clicking of a mouse. In combination with this, additional buttons can be preferably indicated with the progress note so as to provide higher operability in manipulation, including a viewing button for viewing a summary of hospital discharge of the different hospital department, a mailing button for running a mailing program for drafting an electronic mail to be transmitted to the different hospital department, and the like.

Hardware construction of the computer for constituting the medical support apparatus 12 of the present invention can be modified suitably. For example, the medical support apparatus 12 can be constituted by a plurality of server computers discrete from one another for the purpose of increasing performance of processing and reliability. Specifically, a first server computer may constitute the request receiver 50 and the display output control unit 52. A second server computer may constitute the acquisition unit 51. The medical support apparatus can be constituted by the two server computers.

In the first embodiment, the medical support apparatus 12 creates the display screen 19. The client terminal apparatus 11 drives the display panel 29A to display the display screen 19 according to the display data of the display screen 19 from the medical support apparatus 12. However, it is possible to transmit medical care data as resource of the display screen 19 from the medical support apparatus 12 to the client terminal apparatus 11, and to create the display screen 19 in the client terminal apparatus 11. The display output control unit 52 is established in the CPU 27A in the client terminal apparatus 11.

Also, the various circuit devices which are provided in the CPU 27B of the medical support apparatus 12 may be established in the CPU 27A of the client terminal apparatus 11, which can be operated as a medical support apparatus. The request receiver 50 receives a command signal for information delivery from the GUI control unit 35 in place of the request for information delivery. The display output control unit 52 sends the display screen 19 to the GUI control unit 35.

Thus, the construction of the hardware in the computer can be changed suitably according to performance requiring ability for processing, safety, reliability and the like. Additionally, it is also possible to store the control program 40 and other application programs in a duplicated form or divided form in plural storage media for the purpose of ensuring the safety and the reliability.

In the above embodiments, the medical support apparatus 12 is used in one medical facility. However, it is possible to use the medical support apparatus 12 commonly in a plurality of medical facilities.

In the above embodiments, the client terminal apparatus 11 in one medical facility is connected to the medical support apparatus 12 communicably by use of the LAN 13 or other network. The medical support apparatus 12 delivers the display screen 19 of medical support in response to a request from the client terminal apparatus 11. To use the display screen 19 in the plural medical facilities, the medical support apparatus 12 is set on-line with the plural client terminal apparatuses 11 positioned in the medical facilities by use of the wide area network (WAN), such as the Internet, public communication network and the like. Requests from the client terminal apparatuses 11 of the medical facilities are received by the medical support apparatus 12 with the WAN, to deliver the display screen 19 of the medical support to the client terminal apparatus 11. Note that information security should be established for use of the WAN, for example, the Virtual Private Network (VPN) or Hypertext Transfer Protocol Secure (HTTPS) can be preferably used as communication protocol of a high level of security.

The EMRs 17 and the diagnostic images 18 are managed for each one of the medical facilities. A place of installation and manager of the medical support apparatus 12 can be a data center of a service provider (company) separate from the medical facilities, but can be a suitable one of the plural medical facilities.

The present invention is not limited to the above embodiments. Various features of the embodiments and variants of the invention can be combined with each other suitably. Also, the computer-executable program and a storage medium for storing the computer-executable program are included in the scope of the present invention.

According to one embodiment mode of the invention, an operating method for a medical support apparatus for providing plural test data and plural medication data is provided, the test data being data of stored combinations of a test item, a test value and date/time information of a diagnostic test performed to a patient body, the medication data being data of stored combinations of a type, a dose and an administration period of a medicine administered to the patient body. The operating method includes a step of acquiring a relationship dataset constituted by the medication data of at least one medicine for the medicine and the test data of at least one test item for the test item susceptible to influence of administering the medicine to the patient body. Display control of a display screen having a plurality of relationship dataset fields in relation to the relationship dataset is performed, so as to arrange and display the dose and the test value adjacently to one another in a time sequence.

Also, in a preferred embodiment mode of the invention, the receiver further receives manually input designation of addition of medication data of a particular medicine to medication data in the relationship dataset without being designated by the display output control unit.

Preferably, the distinct display form of displaying the designated second test item is a display form of disposing higher than the remaining second test item in the display screen.

Preferably, the distinct display form of displaying the test value is a display form of addition of the date/time information in the display screen.

Preferably, the diagnostic test includes at least one of a vital sign measurement, a blood test and urinalysis.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medical support apparatus for providing plural test data and plural medication data, said test data being data of stored combinations of a test item, a test value and date/time information of a diagnostic test performed to a patient body, said medication data being data of stored combinations of a type, a dose and an administration period of a medicine administered to said patient body, comprising:
an acquisition unit for acquiring a relationship dataset constituted by said medication data of at least one medicine for said medicine and said test data of at least one test item for said test item susceptible to influence of administering said medicine to said patient body; and
a display output control unit for performing display control of a display screen having a plurality of relationship dataset fields in relation to said relationship dataset so as to arrange and display said dose and said test value adjacently to one another in a time sequence.

2. A medical support apparatus as defined in claim 1, wherein said display screen includes first and second display areas;
said first display area includes said relationship dataset fields, and also indicates a test value of a test item different from said test item indicated in said relationship dataset fields in a time sequence;
said second display area indicates test values of plural test items at one time point in a display period of said first display area in a list form;
said test item is constituted by:
a first test item displayed in said first display area;
a second test item displayed in said second display area, and including a test item different from said first test item.

3. A medical support apparatus as defined in claim 2, wherein said display output control unit designates said first test item in said first display area and said second test item in said second display area among test items acquired by said acquisition unit in relation to said test data.

4. A medical support apparatus as defined in claim 3, further comprising a receiver for receiving manually input designation of addition of a particular test item to said first test item without being designated by said display output control unit;
wherein said display output control unit adds said particular test item to said first test item and also to said second test item.

5. A medical support apparatus as defined in claim 4, wherein assuming that said particular test item has been designated for said second test item, said display output control unit performs display of said designated second test item in a distinct display form from remaining said second test item.

6. A medical support apparatus as defined in claim 4, wherein upon adding said particular test item to said second test item, said display output control unit performs display of a test value of alternative date/time information for a test value of said second test item of addition assuming that a test value of same date/time information as remaining said second test item is missing.

7. A medical support apparatus as defined in claim 6, wherein said display output control unit performs display control to display said test value of said alternative date/time information in a distinct display form from a test value of said remaining second test item.

8. A non-transitory computer readable medium for storing a computer-executable program enabling execution of computer instructions to perform operations for providing plural test data and plural medication data, said test data being data of stored combinations of a test item, a test value and date/time information of a diagnostic test performed to a patient body, said medication data being data of stored combinations of a type, a dose and an administration period of a medicine administered to said patient body, said operations comprising:
acquiring a relationship dataset constituted by said medication data of at least one medicine for said medicine and said test data of at least one test item for said test item susceptible to influence of administering said medicine to said patient body; and
performing display control of a display screen having a plurality of relationship dataset fields in relation to said relationship dataset so as to arrange and display said dose and said test value adjacently to one another in a time sequence.

9. A medical support system including a medical support apparatus for providing plural test data and plural medication data, said test data being data of stored combinations of a test item, a test value and date/time information of a diagnostic test performed to a patient body, said medication data being data of stored combinations of a type, a dose and an administration period of a medicine administered to said patient body, and a client terminal apparatus connected to said medical support apparatus by network connection, and provided with said test data and said medication data by said medical support apparatus, said medical support system comprising:
an acquisition unit for acquiring a relationship dataset constituted by said medication data of at least one medicine for said medicine and said test data of at least one test item for said test item susceptible to influence of administering said medicine to said patient body; and
a display output control unit for performing display control of a display screen having a plurality of relationship dataset fields in relation to said relationship dataset so as to arrange and display said dose and said test value adjacently to one another in a time sequence.
